(19) United States
(12) Patent Application Publication
(10) Pub. No.: US 2025/0142488 A1
(43) Pub. Date: May 1, 2025

(54) MANAGING POWER IMBALANCES AND POWER CONTROLS FOR ANTENNAS

(71) Applicant: QUALCOMM Incorporated, San Diego, CA (US)

(72) Inventors: Kexin XIAO, Shanghai (CN); Yu ZHANG, San Diego, CA (US); Hyojin LEE, San Diego, CA (US)

(21) Appl. No.: 18/832,449

(22) PCT Filed: Mar. 17, 2022
(86) PCT No.: PCT/CN2022/081434

§ 371 Date: Jul. 23, 2024

(51) Int. Cl. H04W 52/36; H04W 52/32; H04W 52/42

(52) U.S. Cl. CPC H04W 52/36; H04W 52/325; H04W 52/42

(57) ABSTRACT

Methods, systems, and devices for wireless communication at a communication device are described. The communication device may be configured to support reporting of power imbalances between antennas of the communication device. In some cases, the communication device may report a power imbalance between at least two of the antennas in the form of a power offset value based on a respective antenna polarization. In other cases, the communication device may report the power imbalance between the at least two antennas in the form of a power offset value based on a respective antenna panel. In some other cases, the communication device may be configured to report the power imbalance between the at least two antennas in the form of a power offset value for each separate antenna. The communication device may transmit a report with an indication of the power imbalance (e.g., power offset value) to the network.

### CROSS REFERENCE

The present Application is a 371 national stage filing of International PCT Application No. PCT/CN2022/081434 by XIAO et al. entitled “MANAGING POWER IMBALANCES AND POWER CONTROLS FOR ANTENNAS,” filed Mar. 17, 2022, which is assigned to the assignee hereof, and which is expressly incorporated by reference in its entirety herein.

### INTRODUCTION

The following relates to wireless communication, including power controls for the wireless communication.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

A method for wireless communication at a device is described. The method may include obtaining a power offset value between at least two antennas of a set of antennas associated with the device, where the power offset value indicates a power imbalance corresponding to a difference in an antenna gain between the at least two antennas. In some examples, the method may further include outputting a report which includes an indication of the power offset value between the at least two antennas. In some examples, the method may further include performing wireless communications based on the outputted report.

An apparatus for wireless communication is described. The apparatus may include a processor, and memory coupled with the processor, the processor configured to obtain a power offset value between at least two antennas of a set of antennas associated with the apparatus, where the power offset value indicates a power imbalance corresponding to a difference in an antenna gain between the at least two antennas. In some examples, the instructions may further cause the apparatus to output a report including an indication of the power offset value between the at least two antennas, and perform wireless communications based on the outputted report.

Another apparatus for wireless communication is described. The apparatus may include means for obtaining a power offset value between at least two antennas of a set of antennas associated with the apparatus, where the power offset value indicates a power imbalance corresponding to a difference in an antenna gain between the at least two antennas. In some examples, the apparatus may also include means for outputting a report including an indication of the power offset value between the at least two antennas, and means for performing wireless communications based on the outputted report.

A non-transitory computer-readable medium storing code for wireless communication at a device is described. The code may include instructions executable by a processor to obtain a power offset value between at least two antennas of a set of antennas associated with the device, where the power offset value indicates a power imbalance corresponding to a difference in an antenna gain between the at least two antennas. In some examples, the code may include instructions executable by a processor to output a report including an indication of the power offset value between the at least two antennas, and perform wireless communications based on the outputted report.

Some aspects of the method, apparatuses, and non-transitory computer-readable medium described herein may further include operations, features, means, or instructions for obtaining control signaling that indicates a configuration to report the power offset value between the at least two antennas. In some examples, the method, apparatuses, and non-transitory computer-readable medium may further include operations, features, means, or instructions for outputting the report including the indication of the power offset value between the at least two antennas may be based on the configuration.

In some aspects of the method, apparatuses, and non-transitory computer-readable medium described herein, the control signaling includes a radio resource control (RRC) message, a downlink control information (DCI), a medium access control-control element (MAC-CE), or any combination thereof.

Some aspects of the method, apparatuses, and non-transitory computer-readable medium described herein may further include operations, features, means, or instructions for identifying a power offset threshold value based on the configuration. In some examples, the method, apparatuses, and non-transitory computer-readable medium described herein may further include operations, features, means, or instructions for determining that the power offset value between the at least two antennas, or at least one respective power offset value associated with a respective antenna of the at least two antennas, or both, satisfies the determined power offset threshold value. In some examples, the method, apparatuses, and non-transitory computer-readable medium described herein may further include operations, features, means, or instructions for outputting the report including the indication of the power offset value between the at least two antennas may be further based on that the power offset value between the at least two antennas, or at least one respective power offset value associated with a respective antenna of the at least two antennas, or both, satisfies the determined power offset threshold value.

Some aspects of the method, apparatuses, and non-transitory computer-readable medium described herein may further include operations, features, means, or instructions for setting the power offset value for the at least two antennas based on a respective antenna polarization of each antenna of the at least two antennas.

Some aspects of the method, apparatuses, and non-transitory computer-readable medium described herein may further include operations, features, means, or instructions for setting the power offset value for the at least two antennas based on each antenna of the at least two antennas being configured to a respective antenna panel associated with the device.

Some aspects of the method, apparatuses, and non-transitory computer-readable medium described herein may further include operations, features, means, or instructions for setting a respective power offset value separately for each antenna of the at least two antennas.

Some aspects of the method, apparatuses, and non-transitory computer-readable medium described herein may further include operations, features, means, or instructions for obtaining control signaling that indicates a respective power control parameter for one or more antenna ports associated with each of the at least two antennas based on the outputted report including the indication of the power offset value between the at least two antennas.

Some aspects of the method, apparatuses, and non-transitory computer-readable medium described herein may further include operations, features, means, or instructions for determining a sounding reference signal (SRS) resource for the one or more antenna ports associated with each of the at least two antennas and where the respective power control parameter for the one or more antenna ports associated with each of the at least two antennas may be based on the SRS resource for the one or more antenna ports associated with each of the at least two antennas.

In some aspects of the method, apparatuses, and non-transitory computer-readable medium described herein, the SRS resource for the one or more antenna ports associated with each of the at least two antennas corresponds to an SRS resource associated with both the at least two antennas.

Some aspects of the method, apparatuses, and non-transitory computer-readable medium described herein may further include operations, features, means, or instructions for identifying the respective power control parameter for the one or more antenna ports associated with each of the at least two antennas based on a respective antenna port index for the one or more antenna ports associated with each of the at least two antennas.

In some aspects of the method, apparatuses, and non-transitory computer-readable medium described herein, the SRS resource for the one or more antenna ports associated with each of the at least two antennas corresponds to different SRS resources.

In some aspects of the method, apparatuses, and non-transitory computer-readable medium described herein, the at least two antennas of the set of antennas corresponds to at least two antenna ports for physical uplink shared channel transmission, and each antenna port of the at least two antenna ports corresponds to a respective power control parameter.

In some aspects of the method, apparatuses, and non-transitory computer-readable medium described herein, performing the wireless communication may include operations, features, means, or instructions for determining channel estimation on a channel based on the power offset value between the at least two antennas, the channel including an uplink channel.

In some aspects of the method, apparatuses, and non-transitory computer-readable medium described herein, comprising the set of antennas, the at least two antennas of the set of antennas may be associated with a transmit chain, a receiver chain, or both, associated with the apparatus.

In some aspects of the method, apparatuses, and non-transitory computer-readable medium described herein, the set of antennas include a non-uniform geometric shape.

In some aspects of the method, apparatuses, and non-transitory computer-readable medium described herein, the device includes a UE or a customer premise equipment (CPE).

A method for wireless communication at a network entity is described. The method may include obtaining a report including an indication of a power offset value between at least two antennas of a set of antennas associated with a device, where the power offset value indicates a power imbalance corresponding to a difference in an antenna gain between the at least two antennas and performing the wireless communication with the device based on the report.

An apparatus for wireless communication at a network entity is described. The apparatus may include a processor, and memory coupled with the processor, the processor configured to obtain a report including an indication of a power offset value between at least two antennas of a set of antennas associated with a device, where the power offset value indicates a power imbalance corresponding to a difference in an antenna gain between the at least two antennas and perform the wireless communication with the device based on the report.

Another apparatus for wireless communication at a network entity is described. The apparatus may include means for obtaining a report including an indication of a power offset value between at least two antennas of a set of antennas associated with a device, where the power offset value indicates a power imbalance corresponding to a difference in an antenna gain between the at least two antennas and means for performing the wireless communication with the device based on the report.

A non-transitory computer-readable medium storing code for wireless communication at a network entity is described. The code may include instructions executable by a processor to obtain a report including an indication of a power offset value between at least two antennas of a set of antennas associated with a device, where the power offset value indicates a power imbalance corresponding to a difference in an antenna gain between the at least two antennas and perform the wireless communication with the device based on the report.

Some aspects of the method, apparatuses, and non-transitory computer-readable medium described herein may further include operations, features, means, or instructions for outputting control signaling that indicates a configuration to report the power offset value between the at least two antennas and where obtaining the report including the indication of the power offset value between the at least two antennas may be based on the configuration.

In some aspects of the method, apparatuses, and non-transitory computer-readable medium described herein, the control signaling includes an RRC message, a DCI, a MAC-CE, or any combination thereof.

In some aspects of the method, apparatuses, and non-transitory computer-readable medium described herein, the configuration indicates a power offset threshold value and the report including the indication of the power offset value between the at least two antennas may be based on that the power offset value between the at least two antennas, or at least one respective power offset value associated with a respective antenna of the at least two antennas, or both, satisfies the power offset threshold value.

Some aspects of the method, apparatuses, and non-transitory computer-readable medium described herein may further include operations, features, means, or instructions for assigning a power offset value for the at least two antennas based on a respective antenna polarization of each antenna of the at least two antennas.

Some aspects of the method, apparatuses, and non-transitory computer-readable medium described herein may further include operations, features, means, or instructions for assigning the power offset value for the at least two antennas based on each antenna of the at least two antennas being configured to a respective antenna panel associated with the device.

Some aspects of the method, apparatuses, and non-transitory computer-readable medium described herein may further include operations, features, means, or instructions for assigning a respective power offset value separately for each antenna of the at least two antennas.

Some aspects of the method, apparatuses, and non-transitory computer-readable medium described herein may further include operations, features, means, or instructions for outputting control signaling that indicates a respective power control parameter for one or more antenna ports associated with each of the at least two antennas based on the report including the indication of the power offset value between the at least two antennas.

In some aspects of the method, apparatuses, and non-transitory computer-readable medium described herein, the respective power control parameter for the one or more antenna ports associated with each of the at least two antennas may be based on an SRS resource for the one or more antenna ports associated with each of the at least two antennas.

In some aspects of the method, apparatuses, and non-transitory computer-readable medium described herein, the SRS resource for the one or more antenna ports associated with each of the at least two antennas corresponds to an SRS resource associated with both the at least two antennas.

In some aspects of the method, apparatuses, and non-transitory computer-readable medium described herein, the SRS resource for the one or more antenna ports associated with each of the at least two antennas corresponds to different SRS resources.

### BRIEF DESCRIPTION OF THE DRAWINGS

FIG. 1 illustrates an example of a wireless communications system that supports managing power imbalances and power controls for antennas in accordance with one or more aspects of the present disclosure.

FIG. 2 illustrates an example of a network architecture that supports managing power imbalances and power controls for antennas in accordance with one or more aspects of the present disclosure.

FIG. 3 illustrates an example of a wireless communications system that supports managing power imbalances and power controls for antennas in accordance with one or more aspects of the present disclosure.

FIGS. 4A through 4C illustrate example of block diagrams showing various perspectives of a device that supports managing power imbalances and power controls for antennas in accordance with one or more aspects of the present disclosure.

FIGS. 5A and 5B illustrate examples of antenna port configurations that support managing power imbalances and power controls for antennas in accordance with one or more aspects of the present disclosure.

FIG. 6 illustrates an example of a process flow that supports managing power imbalances and power controls for antennas in accordance with one or more aspects of the present disclosure.

FIGS. 7 and 8 show block diagrams of devices that support managing power imbalances and power controls for antennas in accordance with one or more aspects of the present disclosure.

FIG. 9 shows a block diagram of a communications manager that supports managing power imbalances and power controls for antennas in accordance with one or more aspects of the present disclosure.

FIG. 10 shows a diagram of a system including a device that supports managing power imbalances and power controls for antennas in accordance with one or more aspects of the present disclosure.

FIGS. 11 and 12 show block diagrams of devices that support managing power imbalances and power controls for antennas in accordance with one or more aspects of the present disclosure.

FIG. 13 shows a block diagram of a communications manager that supports managing power imbalances and power controls for antennas in accordance with one or more aspects of the present disclosure.

FIG. 14 shows a diagram of a system including a device that supports managing power imbalances and power controls for antennas in accordance with one or more aspects of the present disclosure.

FIGS. 15 through 19 show flowcharts illustrating methods that support managing power imbalances and power controls for antennas in accordance with one or more aspects of the present disclosure.

### DETAILED DESCRIPTION

A wireless communications system may include a communication device, such as a UE or a network entity (e.g., an eNodeB (eNB), a next-generation NodeB or a giga-NodeB, either of which may be referred to as a gNB, or some other base station), that support wireless communications over one or multiple radio access technologies. Examples of radio access technologies include 4G systems, such as LTE systems, and 5G systems, which may be referred to as NR systems. The wireless communications may include uplink transmission, uplink reception, downlink transmission, or downlink reception, sidelink transmission, sidelink reception, or a combination thereof. A communication device may be configured with multiple antenna arrays having one or more antennas to support high reliability and low latency wireless communications. For example, a UE or a CPE may be configured with multiple antenna arrays to provide coverage enhancement for wireless communications.

Each antenna array of the communication device may be associated with a set of characteristics, such as antenna polarization and antenna gain, which relate to the performance of each antenna array of the communication device. The antenna polarization of an antenna array may refer to a direction of an electromagnetic field produced by the antenna array as energy radiates away from it. These directional fields determine the direction in which the energy moves away from or is received by the antenna array. The antenna gain of an antenna array may refer to how much power is transmitted in the direction of peak radiation. In some cases, the antenna gains between multiple antennas of an antenna array may not be equal. This variation between antennas may be due to non-uniform antenna array patterns, which also leads to differences in polarization between antennas. A non-uniform antenna array pattern may refer to an antenna array that has two or more antennas that are located, positioned, or orientated differently, or any combination thereof. The variation in gain between antennas may lead to high power imbalances (e.g., a power imbalance above a threshold), which may impact wireless communications, among other operations at the communication device (e.g., channel estimation). For example, if a power imbalance is high, such as above a threshold, an antenna of the communication device with a lower antenna gain may have a larger channel estimation error compared to another antenna of the communication device with a higher antenna gain.

Various aspects of the present disclosure relate to enabling a communication device (e.g., a UE, a CPE, or the like) to report power imbalances of an antenna array of the communication device to the network (e.g., a base station, a network entity). For example, the communication device may be configured by the network (e.g., the base station, the network entity) to report a respective power offset value for the antenna array, a respective power offset value for each antenna within the antenna array, or a respective power offset value for a subset of antennas within the antenna array. A power offset value may refer to a difference in antenna gain between two antennas. In some examples, the communication device may be configured to report power imbalances of an antenna array based on a condition. For example, the communication device may determine that a power offset value between different antennas of the antenna array is above a threshold value (e.g., configured by the network). Based on this determination, the communication device may report the power offset value to the network.

Additionally or alternatively, the communication device may be configured by the network with different power control parameters for different antenna ports (e.g., reference signal ports) associated with the antenna array. Antenna port may refer to antennas with identical channel conditions. In some examples, the power control parameter may be configured based on an antenna port index. In other examples, the power control parameter may be configured based on each reference signal resource associated with a respective antenna port. Additionally or alternatively, the network may configure different power control parameters for various antenna ports of the communication device (e.g., a UE) to provide coverage enhancement for wireless communications (e.g., physical uplink shared channel (PUSCH) transmission).

The described techniques may provide for high reliability and low latency wireless communication based on managing power imbalances at a communication device. For example, by reporting power imbalances, the communication device may provide better channel estimations, which may result in high reliability and low latency wireless communications. For example, the communication device may adjust, modify, configure, re-configure one or more power control parameters that control a power value associated with the one or more antennas of the communication device. By adjusting, modifying, configuring, or re-configuring the one or more power control parameters, the communication device may avoid power imbalances between antennas and be able to transmit or receive reference signals effectively to perform channel estimation. Additionally, or alternatively, the described techniques may increase coverage for wireless communication. For example, by reporting power imbalances, the communication device may decrease or mitigate power imbalances between antennas of the communication device because the network may configure (re-configure) one or more power control parameters associated with the antennas for the communication device based on the reported power imbalances.

Aspects of the disclosure are initially described in the context of wireless communications systems. Aspects of the disclosure are further illustrated by and described with reference to apparatus diagrams, system diagrams, and flowcharts that relate to managing power imbalances and power controls for antennas.

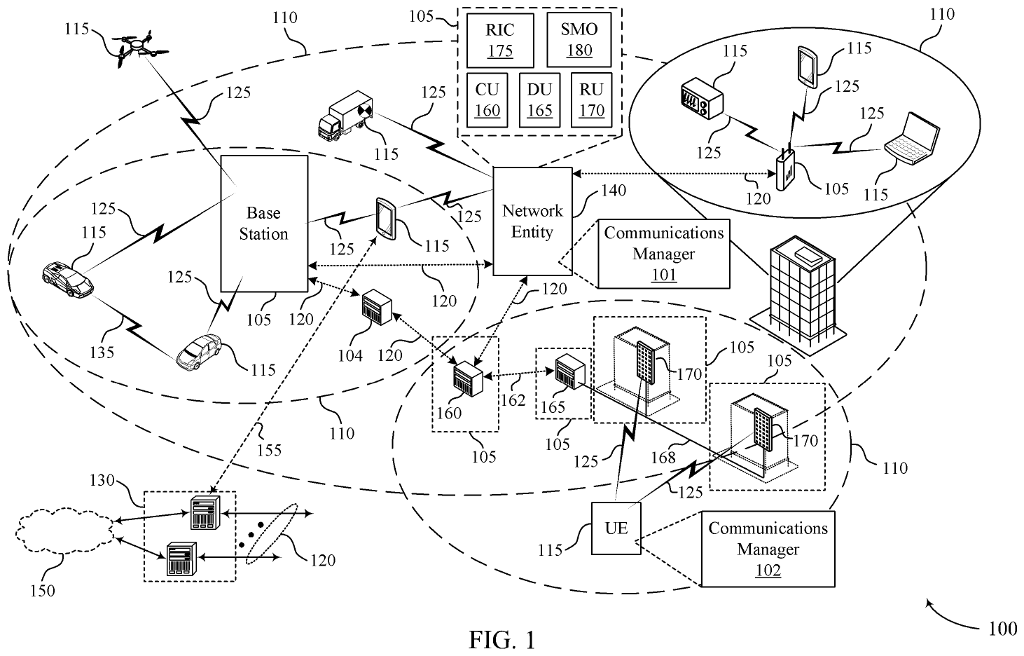

FIG. 1 illustrates an example of a wireless communications system 100 that supports managing power imbalances and power controls for antennas in accordance with one or more aspects of the present disclosure. The wireless communications system 100 may include one or more network entities 105, one or more UEs 115, and a core network 130. In some examples, the wireless communications system 100 may be an LTE network, an LTE-A network, an LTE-A Pro network, an NR network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1,F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support managing power imbalances and power controls for antennas as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-(V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). The region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The electromagnetic spectrum is often subdivided, based on frequency/wavelength, into various classes, bands, channels, etc. In 5G NR two initial operating bands have been identified as frequency range designations FR1 (410 MHz-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to provide link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may increase throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

A UE 115 may be equipped with multiple antennas for transmission and reception of wireless communications. Often, multiple antennas may be organized into antenna arrays having a uniform planar shape. An antenna array may include two or more antennas that operate together to produce a signal. Antennas within an antenna array may utilize the same polarization, that is the antennas may propagate electromagnetic waves in the same direction. In other words, an antenna array may have an associated polarization. In some cases, the UE 115 may be equipped with multiple antenna arrays that are organized in a non-uniform shape. For example, a cylindrical CPE may be an example UE 115 and have antennas placed on the top and bottom of the UE 115 with each antenna array utilizing a different polarization.

The UE 115 may utilize a first antenna array with a horizontal polarization and a second antenna array with a vertical polarization. These differences in polarization may cause variations in antenna gains between the antenna arrays. In some cases, the difference in antenna gain between antennas or antenna arrays may average 3 decibels (dB). Antennas may also experience large differences in gain due to distance. For example, antennas that are located far away from each other (e.g., an antenna on the top of a CPE and an antenna on the bottom of the CPE) may experience large variations in gain. Additionally or alternatively, the location or placement of the antennas within the UE 115 may also be a factor in antenna gain variation. When the UE 115 has less than four antennas, this variation in antenna gains may be insignificant. However, when the UE 115 has four or more antennas, the difference in antenna gains between the antennas may lead to significant power imbalance. Although four or more antennas is described in various examples herein, it should be understood that any number of antennas, such as two or more antennas may be realized for implementing one or more aspects that support managing power imbalances and power controls for antennas in accordance with one or more aspects of the present disclosure.

A network entity 105 (or a base station 140) may schedule uplink resources based on SRSs received from the UE 115. An SRS may serve as an uplink reference signal to test the channel quality and may indicate factors such as the power loss of transmitted signals. The network entity 105 (or the base station 140) may perform channel estimation using the SRS and determine a precoding matrix for transmitting an uplink grant. Channel estimation may include predicting channel conditions based on channel measurements. The precoding matrix may include a transmit precoding matrix index and rank information to be transmitted on a physical downlink control channel (PDCCH) as part of the uplink grant. However, if the UE 115 experiences large power imbalances the SRS received by the network entity 105 (or the base station 140) may not be accurate. For example, antenna power imbalance may not be conducive to uplink codebooks used by the network entity 105 (or the base station 140) which may have constant-value elements. Thus, low antenna gain at the UE 115 may be correlated with large channel estimation error at the network entity 105 (or the base station 140). This may lead to unreliable channel estimations and decreased overall performance. The wireless communications system 100 may support power control for the UE by configuring the UE 115 to determine a power offset value between antennas and transmit a report to the network entity 105 (or the base station 140) with an indication of the power offset value.

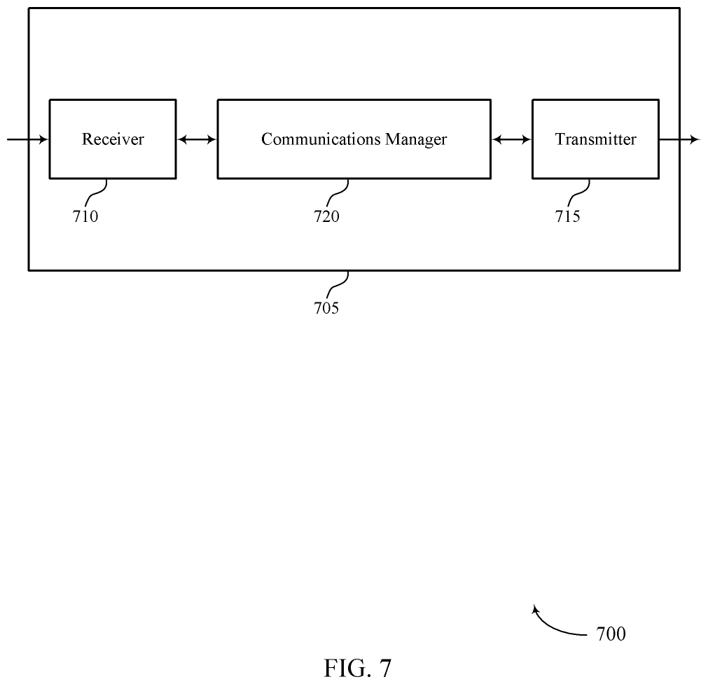

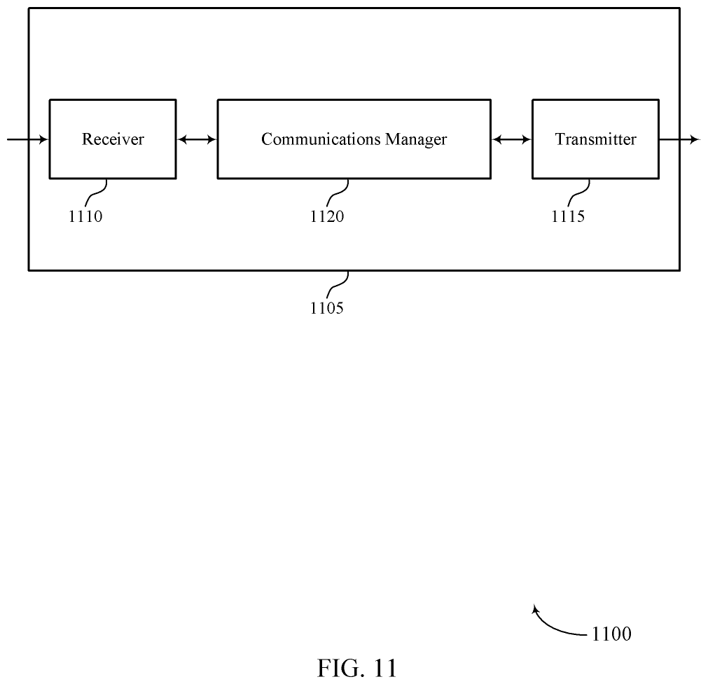

A network entity 105 (or a base station 140) may include a communications manager 101 that may support wireless communication in accordance with examples as disclosed herein. The communications manager 101 may be an example of aspects of a communications manager as described in FIGS. 11 through 14. For example, the communications manager 101 may support managing power imbalances and power controls for antennas in accordance with one or more aspects of the present disclosure. A UE 115 may include a communications manager 102 that may support wireless communication in accordance with examples as disclosed herein. The communications manager 102 may be an example of aspects of a communications manager as described in FIGS. 7 through 10. For example, the communications manager 102 may support managing power imbalances and power controls for antennas in accordance with one or more aspects of the present disclosure.

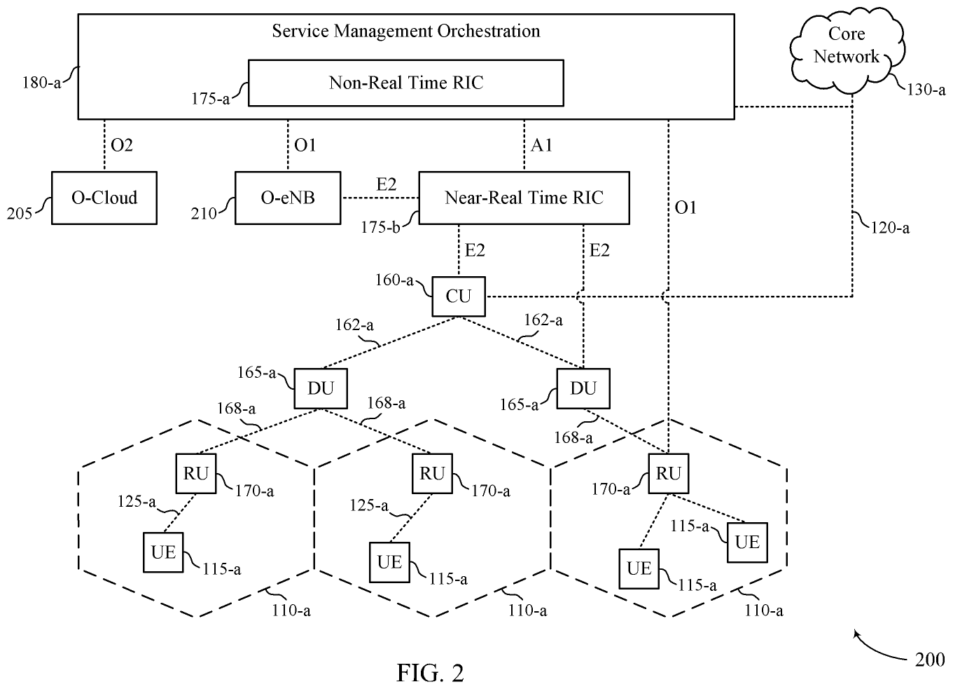

FIG. 2 illustrates an example of a network architecture 200 (e.g., a disaggregated base station architecture, a disaggregated RAN architecture) that supports managing power imbalances and power controls for antennas in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may communicate with respective UEs 115-a via one or more communication links 125-a. In some implementations, a UE 115-a may be simultaneously served by multiple RUs 170-a. An RU 170-a may support a coverage area 110-a (e.g., a geographic coverage area) over which a UE 115-a and the RU 170-a may establish one or more communication links 125-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g. via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

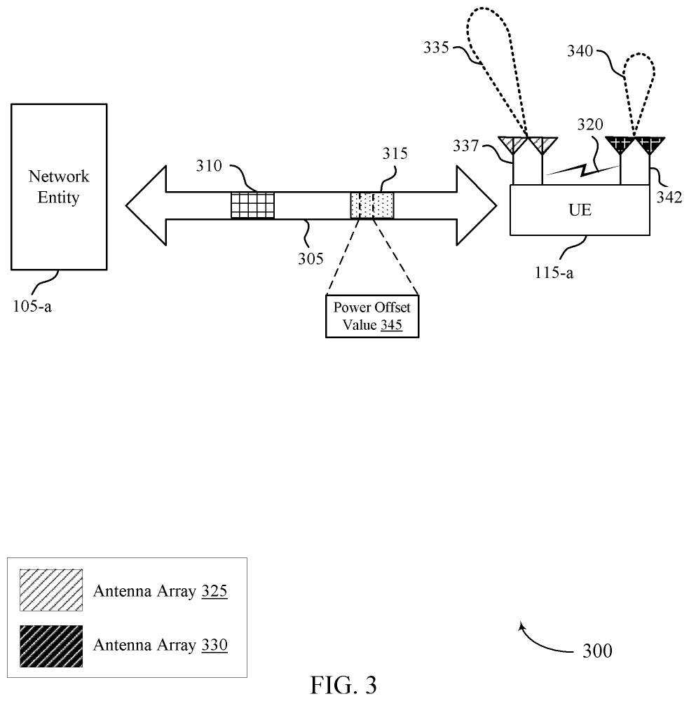

FIG. 3 illustrates an example of a wireless communications system 300 that supports managing power imbalances and power controls for antennas in accordance with one or more aspects of the present disclosure. The wireless communications system 300 may implement or be implemented by aspects of the wireless communications system 100 or the network architecture 200 as described in FIGS. 1 and 2, respectively. For example, the wireless communications system 300 may include a network entity 105-a and a UE 115-a, which may be examples of a network entity 105 and a UE 115 as described with reference to FIG. 1. In some examples, the wireless communications system 300 may support multiple radio access technologies including 4G systems such as LTE systems, LTE-A systems, or LTE-A Pro systems, and 5G systems which may be referred to as NR systems, including future systems and radio technologies not explicitly mentioned herein. The wireless communications system 300 may support power saving, and, in some examples, may promote high reliability and low latency wireless communications.

The network entity 105-a and the UE 115-a may support wireless communication over a communication link 305, which may be examples of a communication link 125 as described with reference to FIG. 1. The network entity 105-a and the UE 115-a may be equipped with multiple antennas, which may be used to employ techniques as described herein. The antennas of the network entity 105-a or the UE 115-a, or both, may be located within one or more antenna arrays or antenna panels, which may support operations as described herein. The network entity 105-a may have an antenna array with a number of rows and columns of antenna ports that the network entity 105-a may use to support wireless communications with the UE 115-a. Likewise, the UE 115-a may have one or more antenna arrays that may support various operations as described herein. Additionally or alternatively, the UE 115-a may have an antenna array with a number of rows and columns of antenna ports that the UE 115-a may use to support wireless communications with the network entity 105-a. One or more antennas or antenna arrays may be part of a transmit chain, a receiver chain, or both. A transmit chain may refer to a number of antennas including other circuit elements, which may include amplifiers, filters, mixers, attenuators and detector that are configured for transmitting signals (e.g., control information, data). A receiver chain may refer to a number of antennas including other circuit elements, which may include amplifiers, filters, mixers, attenuators and detector that are configured for receiving signals (e.g., control information, data).

In the example of FIG. 3, the UE 115-a may be equipped with an antenna array 325, which may be associated with an antenna gain 335 and an antenna polarization 337. The UE 115-a may also be equipped with an antenna array 330, which may be associated with an antenna gain 340 and an antenna polarization 342 different from the antenna polarization 337. The antenna array 325 and the antenna array 330 may experience different values of the antenna gain 335 and the antenna gain 340, respectively. The difference in values between the antenna gain 335 and the antenna gain 340 may be due to differences in the antenna polarization 337 and the antenna polarization 342. Additionally, the difference in values between the antenna gain 335 and the antenna gain 340 may also be due to a location or a distance between the antenna array 325 and the antenna array 330. In some cases, the difference in values between the antenna gain 335 and the antenna gain 340 may result in a power imbalance 320 between the antenna array 325 and the antenna array 330.

The network entity 105-a may transmit or output, and the UE 115-a may receive or obtain, a configuration 310 to report the power imbalance 320 as a power offset value 345 (also referred to as a static power offset value) between the antenna array 325 and the antenna array 330. In some examples, the network entity 105-a may transmit or output, and the UE 115-a may receive or obtain, the configuration 310 via an RRC configuration message. In some other examples, the network entity 105-a may transmit or output, and the UE 115-a may receive or obtain, the configuration 310 via a DCI. In other examples, the network entity 105-a may transmit or output, and the UE 115-a may receive or obtain, the configuration 310 via a MAC-CE.

The UE 115-a may transmit, to the network entity 105-a, a report 315 that includes an indication of a power offset value 345 between the antenna array 325 and the antenna array 330. In some examples, the power offset value 345 may be between at least two antennas of the antenna array 325. In some other examples, the power offset value 345 may be between a least two antennas of the antenna array 330. In other examples, the power offset value 345 may be between at least one antenna of the antenna array 325 and at least one antenna of the antenna array 330. In some cases, the UE 115-a may report the power offset value 345 based on a condition. For example, the UE 115-a may report the power offset value 345 when the power offset value 345 satisfies a power offset threshold value (e.g., is greater than or equal to the power offset threshold value). The UE 115-a may identify the power offset threshold value based on the received or obtained the configuration 310 from the network entity 105-a. Additionally or alternatively, the UE 115-a may transmit the report 315 periodically or aperiodically based on the received or obtained the configuration 310 from the network entity 105-a. In some other examples, the UE 115-a may transmit the report 315 based on an elapsed time interval (e.g., an expiration of a timer).

The UE 115-a may be configured by the network entity 105-a (e.g., via the configuration 310) to report the power offset value 345 based antenna polarizations. The UE 115-a may set the power offset value 345 for at least two antennas (e.g., associated with the antenna array 325 and/or the antenna array 330) based on a respective antenna polarization of each antenna of the at least two antennas (e.g., associated with the antenna polarization 337 and/or the antenna polarization 342). For example, the UE 115-a may set the same power offset value for antennas with the same polarization (or different polarization). As such, in some examples, the UE 115-a may report a single power offset value for antennas associated with the same polarization (or different polarization).

The UE 115-a may set the power offset value 345 for at least two antennas (e.g., associated with the antenna array 325 and/or the antenna array 330) based on each antenna of the at least two antennas being configured to a respective antenna panel associated with the UE 115-a. For example, the UE 115-a may set the same power offset value for antennas within the same antenna panel (or different antenna panel). As such, in some other examples, the UE 115-a may report a single power offset value for antennas associated with the same antenna panel (or different antenna panel). Additionally or alternatively, the UE 115-a may set a respective power offset value separately for each antenna of the at least two antennas (e.g., associated with the antenna polarization 337 and/or the antenna polarization 342). As such, the UE 115-a may set and report power offset value separately for each antenna of the at least two antennas (e.g., associated with the antenna polarization 337 and/or the antenna polarization 342), for example, where there are no relations between the at least two antennas.

Accordingly, the wireless communications system 300 including the network entity 105-a and the UE 115-a may provide better channel estimation based on enabling the UE 115-a to report power imbalances between antennas, antenna arrays, and/or antenna panels of the UE 115-a. By reporting the power imbalances, the network entity 105-a and the UE 115-a may compensate for the power imbalances by adjusting one or more power controls as described herein.

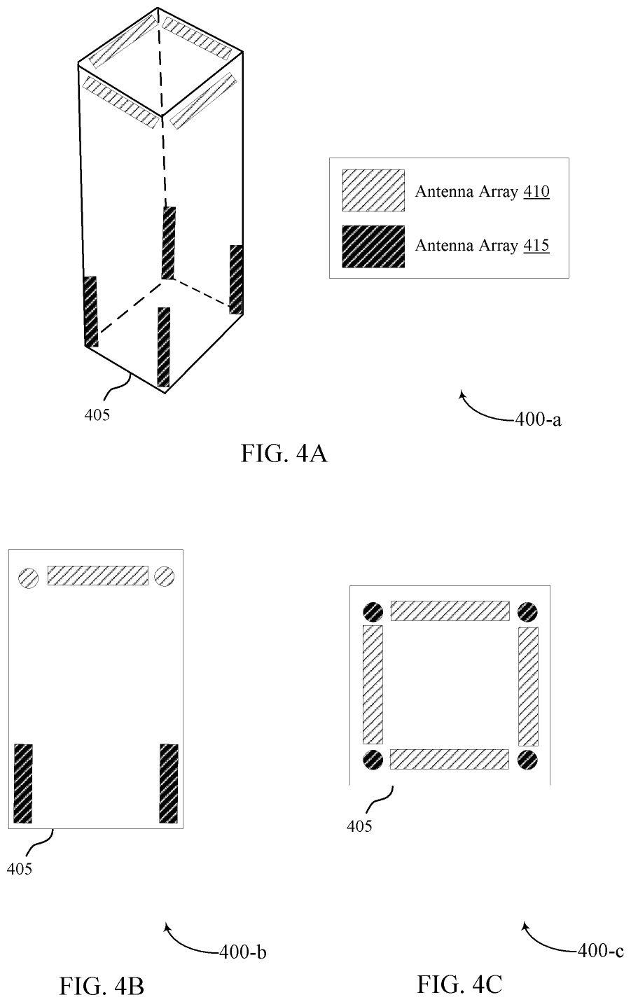

FIG. 4A illustrates examples of a block diagram 400-a showing a front perspective of a device 405 that supports managing power imbalances and power controls for antennas in accordance with one or more aspects of the present disclosure. FIG. 4B illustrates examples of a block diagram 400-b showing a side perspective of a device 405 that supports managing power imbalances and power controls for antennas in accordance with one or more aspects of the present disclosure. FIG. 4C illustrates examples of a block diagram 400-c showing a top perspective of a device 405 that supports managing power imbalances and power controls for antennas in accordance with one or more aspects of the present disclosure. The device 405 may implement or be implemented by aspects of the wireless communications systems 100 and 300 as described with reference to FIGS. 1 and 3, respectively. For example, the device 405 may be an example of aspects of a network entity 105 or a UE 115 as described herein. In some examples, the device 405 may be a CPE.

The device 405 may provide a means for receiving information such as packets, user data, control information, or any combination thereof associated with various information channels (e.g., control channels, data channels, information channels related to managing power imbalances and power controls for the device 405). Additionally or alternatively, the device 405 may provide means for transmitting signals generated by other components of the device 405. For example, the device 405 may transmit information such as packets, user data, control information, or any combination thereof associated with various information channels (e.g., control channels, data channels, information channels related to managing power imbalances and power controls for the device 405).

The device 405 may include one or multiple antenna arrays to support high reliability and low latency wireless communications. Additionally, the device 405 may be configured with multiple antenna arrays to provide coverage enhancement for wireless communications. For example, the device 405 may be configured with a first antenna array 410 and a second antenna array 415. Each of the first antenna array 410 or the second antenna array 415 may include one or more antennas. In the example of FIGS. 4A through 4C, the first antenna array 410 may include four antennas, and the second antenna array 415 may include four antennas. It should be noted that the number of antennas or antenna arrays, or both, described herein describe possible implementations, and that the number of antennas or antenna arrays, or both may be modified and that other implementations are possible (e.g., greater than four antennas per antenna array, or less than four antennas per antenna array).

In some examples, the first antenna array 410 may be associated with a first antenna polarization (e.g., a horizontal antenna polarization), while the second antenna array 415 may be associated with a second antenna polarization (e.g., a vertical antenna polarization) different from the first antenna polarization. A horizontal antenna polarization may refer to an electric field being oriented parallel to an Earth's surface. A vertical antenna polarization may refer to an electric field being orient horizontal to an Earth's surface. Although horizontal and vertical antenna polarization are illustrated in these examples, the first antenna array 410 and the second antenna array 415 may be of any two differing forms of antenna polarization. For example, the first antenna array 410 and the second antenna array 415 may be polarized with slant polarization, circular polarization, or elliptical polarization, or the like.

In some cases, one or more antennas of the first antenna array 410 may experience a stronger antenna gain than one or more antennas of the second antenna array 415 due to the differences in antenna polarization. In some examples, each antenna of the first antenna array 410 may experience similar or identical antenna gain values. Similarly, each antenna of the second antenna array 415 may experience similar or identical antenna gain value. As such, in some cases, the device 405 may be configured to report a single power offset value per antenna polarization as described herein.

In the example of FIGS. 4A through 4C, antennas of the first antenna array 410 are positioned perpendicular to each other and located at the top of the CPE. Antennas of the second antenna array 415 are positioned parallel to each other and located at the bottom of the device 405. The positioning of the first antenna array 410 and the second antenna array 415 at the device 405 may be referred to as a non-uniform shape because the antenna arrays have different polarizations. In some examples, power imbalance may also be caused by the distance separating the first antenna array 410 and the second antenna array 415. Additionally or alternatively, the placement of the first antenna array 410 and the second antenna array 415 at the device 405 (e.g., top, bottom, side) may also impact the power imbalance between the first antenna array 410 and the second antenna array 415 as described herein.

Although FIGS. 4A through 4C, illustrate the same number of antennas for both the first antenna array 410 and the second antenna array 415, it should be understood that any number of antennas may be realized for implementing one or more aspects that support managing power imbalances and power controls for antennas in accordance with one or more aspects of the present disclosure. That is, the first antenna array 410 may have more or fewer antennas than the second antenna array 415. Alternatively, the second antenna array 415 may have more or fewer antennas than the first antenna array 410. As described herein the power imbalance between the first antenna array 410 and the second antenna array 415 may occur when at least one antenna of the first antenna array 410 and at least one antenna of the second antenna array 415 are located, positioned, or orientated, or any combination, differently with respect to each other.

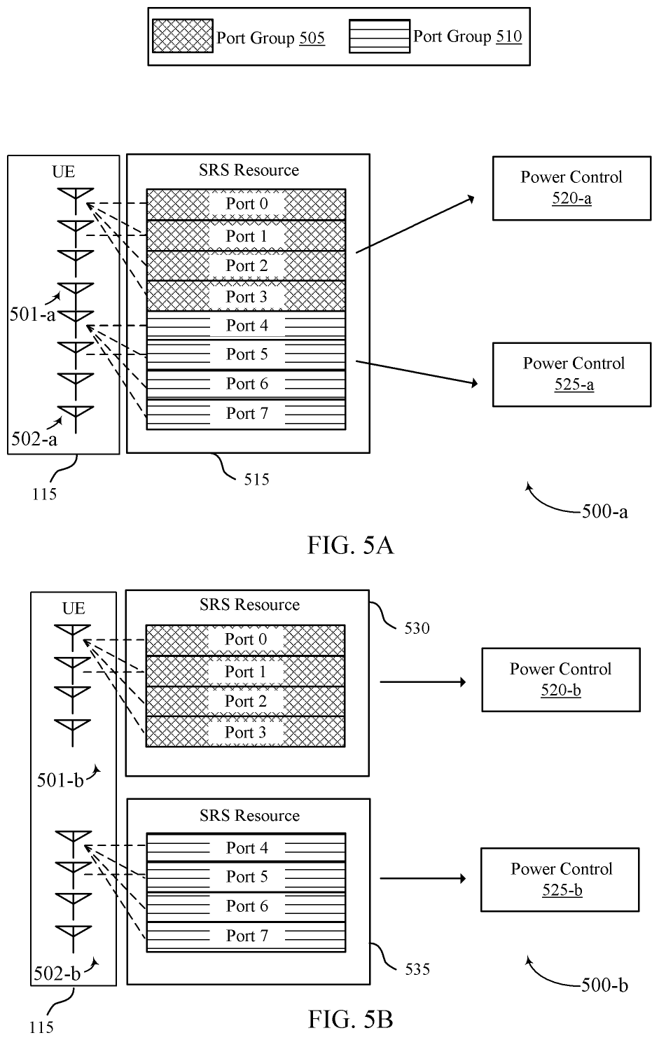

FIG. 5A illustrates an example of an antenna port configuration 500-a that supports managing power imbalances and power controls for antennas in accordance with one or more aspects of the present disclosure. The antenna port configuration 500-a may implement or be implemented by aspects of the wireless communications systems 100 and 300 as described with reference to FIGS. 1 and 3, respectively. For example, the antenna port configuration 500-a may be implemented by a network entity 105 and a UE 115, which may be an example of a network entity 105 and a UE 115 as described with reference to FIGS. 1 and 3, respectively. The antenna port configuration 500-a may include a first group of antenna ports 505 (also referred to as port group) and a second group of antenna ports 510 (also referred to as port group). Each of the first group of antenna ports 505 or the second group of antenna ports 510, or both, may include one or more antenna ports. For example, the first group of antenna ports 505 may include an antenna port 0, an antenna port 1, an antenna port 2, and an antenna port 3, while the second group of antenna ports 510 may include an antenna port 4, an antenna port 5, an antenna port 6, and an antenna port 7.

Each of one or more antenna ports of the first group of antenna ports 505 may be mapped (e.g., associated with) to a set of antennas 501-a of the UE 115. In some examples, each antenna port of the first group of antenna ports 505 may be mapped to a respective antenna (e.g., a separate antenna) of the set of antennas 501-a. For example, a first antenna of the set of antennas 501-a may be mapped to the antenna port 0 and a second antenna of the set of antennas 501-a may be mapped to the antenna port 1. In some other examples, two or more antenna ports of the first group of antenna ports 505 may be mapped to a respective antenna (e.g., a same antenna) of the set of antennas 501-a. For example, a first antenna of the set of antennas 501-a may be mapped to the antenna port 0, the antenna port 1, the antenna port 2, or the antenna port 3, or any combination thereof. It should be understood that any number of antenna ports may be mapped to any number of antennas.

Likewise, each of one or more antenna the second group of antenna ports 510 may be mapped (e.g., associated with) to a set of antennas 502-a of the UE 115. In some examples, each antenna port of the second group of antenna ports 510 may be mapped to a respective antenna (e.g., a separate antenna) of the set of antennas 502-a. For example, a first antenna of the set of antennas 502-a may be mapped to the antenna port 4 and a second antenna of the set of antennas 502-a may be mapped to the antenna port 5. In some other examples, two or more antenna ports of the second group of antenna ports 510 may be mapped to a respective antenna (e.g., a same antenna) of the set of antennas 502-a. For example, a first antenna of the set of antennas 502-a may be mapped to the antenna port 4, the antenna port 5, the antenna port 6, or the antenna port 7, or any combination thereof. It should be understood that any number of antenna ports may be mapped to any number of antennas.

A network entity 105 may determine (e.g., configure, obtain, select, identify) different power control parameters for each respective antenna port of the first group of antenna ports 505 or the second group of antenna ports 510, or both, of the UE 115 for SRS signaling. In the example of FIG. 5A, the first group of antenna ports 505 and the second group of antenna ports 510 may be configured (e.g., part of) a single SRS resource 515. In this example, the network entity 105 may configure power control parameters based on a port index. For example, the network entity 105 may determine (e.g., configure, obtain, select, identify) a first power control parameter 520-a for the first group of antenna ports 505 and a second power control parameter 525-a for the second group of antenna ports 510. In some examples, one or both of the first power control parameter 520-a or the second power control parameter 525-a may include a separate power control parameter for each respective antenna port associated with one or both of the first group of antenna ports 505 or the second group of antenna ports 510.

The power control parameters for each respective antenna port associated with one or both of the first group of antenna ports 505 or the second group of antenna ports 510 may address power imbalance issues between at least two antennas of the UE 115. In other words, due to power imbalance between at least two antennas of the UE 115, channel estimation based on one or more SRS transmission via one or both of the first group of antenna ports 505 or the second group of antenna ports 510 may be inaccurate or suboptimal. The UE 115 may compensate for these inaccuracies by adjusting one or more power controls associated with the one or more antenna ports of one or both of the first group of antenna ports 505 or the second group of antenna ports 510 for the transmission of the one or more SRS by the UE 115. As a result, channel estimation may be better at the network entity 105 and the UE 115. Additionally or alternatively, the network entity 105 may configure power control parameters (e.g., different power control parameters) for the antenna ports associated with one or both of the first group of antenna ports 505 or the second group of antenna ports 510 for PUSCH transmission. The relative power offset between antenna ports might be the same as for the SRS power control.

FIG. 5B illustrates an example of an antenna port configuration 500-b that supports managing power imbalances and power controls for antennas in accordance with one or more aspects of the present disclosure. The antenna port configuration 500-b may implement or be implemented by aspects of the wireless communications systems 100 and 300 as described with reference to FIGS. 1 and 3, respectively. For example, the antenna port configuration 500-b may be implemented by a network entity 105 and a UE 115, which may be an example of a network entity 105 and a UE 115 as described with reference to FIGS. 1 and 2, respectively. The antenna port configuration 500-b may include a first group of antenna ports 505 (also referred to as a port group) and a second group of antenna ports 510 (also referred to as a port group). Each of the first group of antenna ports 505 or the second group of antenna ports 510, or both, may include one or more antenna ports. For example, the first group of antenna ports 505 may include an antenna port 0, an antenna port 1, an antenna port 2, and an antenna port 3, while the second group of antenna ports 510 may include an antenna port 4, an antenna port 5, an antenna port 6, and an antenna port 7.

A network entity 105 may determine (e.g., configure, obtain, select, identify) different power control parameters for each respective antenna port of the first group of antenna ports 505 or the second group of antenna ports 510, or both, of the UE 115 for SRS signaling. In the example of FIG. 5B, the first group of antenna ports 505 and the second group of antenna ports 510 may be configured (e.g., part of) with different SRS resources (different SRS resources). For example, the first group of antenna ports 505 may be configured (e.g., part of) a first SRS resource 530, while the second group of antenna ports 510 may be configured (e.g., part of) a second SRS resource 535. In this example, the network entity 105 may configure power control parameters based on each SRS resource. For example, the network entity 105 may determine (e.g., configure, obtain, select, identify) a first power control parameter 520-b for the first group of antenna ports 505 and a second power control parameter 525-b for the second group of antenna ports 510. In some examples, one or both of the first power control parameter 520-b or the second power control parameter 525-b may include a separate power control parameter for each respective antenna port associated with one or both of the first group of antenna ports 505 or the second group of antenna ports 510.

Each of one or more antenna ports of the first group of antenna ports 505 may be mapped (e.g., associated with) to a set of antennas 501-b of the UE 115. In some examples, each antenna port of the first group of antenna ports 505 may be mapped to a respective antenna (e.g., a separate antenna) of the set of antennas 501-b. For example, a first antenna of the set of antennas 501-b may be mapped to the antenna port 0 and a second antenna of the set of antennas 501-b may be mapped to the antenna port 1. In some other examples, two or more antenna ports of the first group of antenna ports 505 may be mapped to a respective antenna (e.g., a same antenna) of the set of antennas 501-b. For example, a first antenna of the set of antennas 501-b may be mapped to the antenna port 0, the antenna port 1, the antenna port 2, or the antenna port 3, or any combination thereof. It should be understood that any number of antenna ports may be mapped to any number of antennas.

Likewise, each of one or more antenna the second group of antenna ports 510 may be mapped (e.g., associated with) to a set of antennas 502-b of the UE 115. In some examples, each antenna port of the second group of antenna ports 510 may be mapped to a respective antenna (e.g., a separate antenna) of the set of antennas 502-b. For example, a first antenna of the set of antennas 502-b may be mapped to the antenna port 4 and a second antenna of the set of antennas 502-b may be mapped to the antenna port 5. In some other examples, two or more antenna ports of the second group of antenna ports 510 may be mapped to a respective antenna (e.g., a same antenna) of the set of antennas 502-b. For example, a first antenna of the set of antennas 502-b may be mapped to the antenna port 4, the antenna port 5, the antenna port 6, or the antenna port 7, or any combination thereof. It should be understood that any number of antenna ports may be mapped to any number of antennas.

The power control parameters for each respective antenna port associated with one or both of the first group of antenna ports 505 or the second group of antenna ports 510 may address power imbalance issues between at least two antennas of the UE 115. In other words, due to power imbalance between at least two antennas of the UE 115, channel estimation based on one or more SRS transmission via one or both of the first group of antenna ports 505 or the second group of antenna ports 510 may be inaccurate or suboptimal. The UE 115 may compensate for these inaccuracies by adjusting one or more power controls associated with the one or more antenna ports of one or both of the first group of antenna ports 505 or the second group of antenna ports 510 for the transmission of the one or more SRS by the UE 115. As a result, channel estimation may be better at the network entity 105 and the UE 115. Additionally or alternatively, the network entity 105 may configure power control parameters (e.g., different power control parameters) for the antenna ports associated with one or both of the first group of antenna ports 505 or the second group of antenna ports 510 for PUSCH transmission. The relative power offset between antenna ports might be the same as for the SRS power control.

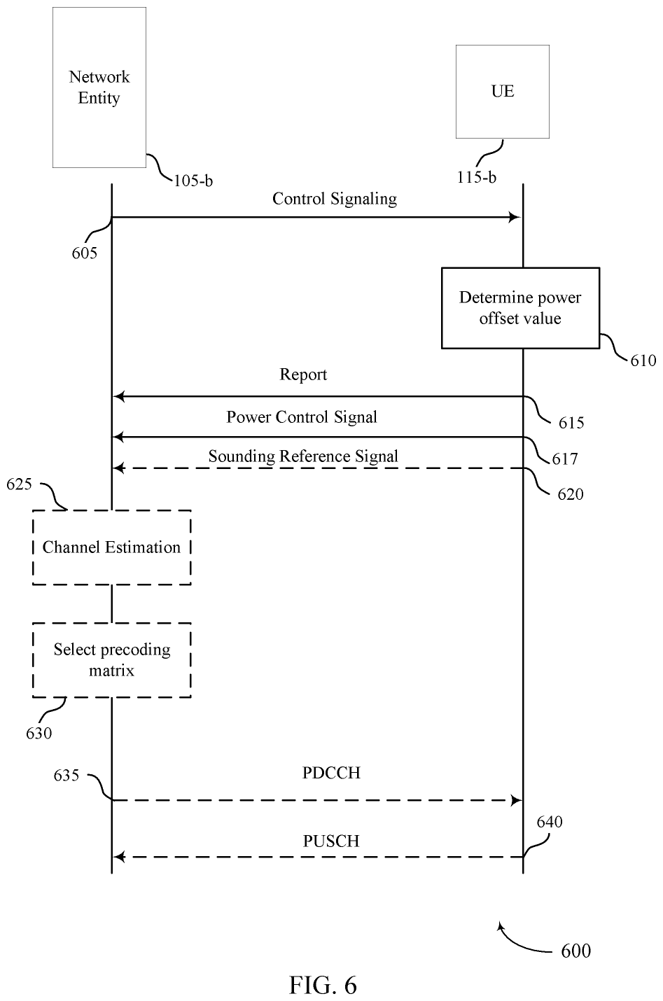

FIG. 6 illustrates an example of a process flow 600 that supports managing power imbalances and power controls for antennas in accordance with one or more aspects of the present disclosure. In some examples, the process flow 600 may implement or be implemented by aspects of the wireless communications systems 100 and 300 as described with reference to FIGS. 1 and 3, respectively. For example, the process flow 600 may be implemented by a network entity 105-b and a UE 115-b, which may be an example of a network entity 105 and a UE 115 as described with reference to FIGS. 1 and 3, respectively. The process flow 600 may be implemented by the network entity 105-b and the UE 115-b to exchange signaling (output control signaling) to promote power saving at the UE 115-b and reliable communications between the network entity 105-a and the UE 115-b. In the following description of the process flow 600, the operations between the network entity 105-b and the UE 115-b may be transmitted in a different order than the example order shown, or the operations performed by the network entity 105-b and the UE 115-b may be performed in different orders or at different times. Some operations may also be omitted from the process flow 600, and other operations may be added to the process flow 600.

At 605, the network entity 105-b may transmit (e.g., output), and the UE 115-b may receive (e.g., obtain), control signaling that indicates a configuration for the UE 115-b to report power imbalances between antennas of the UE 115-b. In some examples, the network entity 105-b may transmit, and the UE 115-b may receive, a RRC message that indicates the configuration for the UE 115-b to report power offset values between antennas of the UE 115-b. In some other examples, the network entity 105-b may transmit, and the UE 115-b may receive, a DCI or a MAC-CE, or both, that indicates the configuration for the UE 115-b to report power offset values between antennas of the UE 115-b. Additionally, the configuration may indicate a condition that triggers the UE 115-b to report the power imbalances between antennas of the UE 115-b. For example, the condition may include that the UE 115-b reports the power imbalances between antennas of the UE 115-b when a power offset value between at least two antennas of the UE 115-b satisfies a threshold (e.g., is greater than or equal to a power threshold. In some other examples, the condition may include that the UE 115-b reports the power imbalances between antennas of the UE 115-b periodically or a-periodically (e.g., after elapsed period of time).

At 610, the UE 115-b may determine a power offset value between at least two antennas of the UE 115-b. The power offset value may indicate a power imbalance between the at least two antennas of the UE 115-b. In some cases, the UE 115-b may be configured to determine and a set a power offset value for the at least two antennas based on a respective antenna polarization of the at least two antennas. In some examples, the UE 115-b may be configured to set the same power offset value for the at least two antennas based on the at least two antennas having the same antenna polarization. Alternatively, the UE 115-b may be configured to set a different power offset value for the at least two antennas based on the at least two antennas having a different antenna polarization. In some other examples, the UE 115-b may be configured to set the same power offset value for the at least two antennas based on the at least two antennas being configured to (e.g., part of) the same antenna panel. Alternatively, the UE 115-b may be configured to set a different power offset value for the at least two antennas based on the at least two antennas being configured to (e.g., part of) different antenna panels. As such, the UE 115-b may be configured to set a power offset value for each antenna of the UE 115-b, respectively.

At 615, the UE 115-b may transmit, and the network entity 105-b may receive (e.g., obtain), a report including an indication of the power offset value between at least two antennas of the UE 115-b. In some examples, the UE 115-b may transmit, and the network entity 105-b may receive, an RRC message reporting the power offset value between at least two antennas of the UE 115-b. In some other examples, the UE 115-b may transmit, and the network entity 105-b may receive, a MAC-CE reporting the power offset value between at least two antennas of the UE 115-b. In other examples, the UE 115-b may transmit, and the network entity 105-b may receive, an uplink control information (UCI) reporting the power offset value between at least two antennas of the UE 115-b. At 617, the UE 115-b may transmit, and the network entity 105-b may receive, a power control signal. The power control signal may carry one or more power control parameters, which may be partially based on the power offset reporting.

At 620, the UE 115-b may transmit, and the network entity 105-b may receive (e.g., obtain), one or more SRSs associated with one or more antenna ports of the at least two antennas of the UE 115-b. An SRS is a reference signal transmitted by the UE 115-b to the network entity 105-b, which may use the received SRS to estimate a channel quality between the network entity 105-b and the UE 115-b. That is, based on the SRS, the network entity 105-b estimate the channel between the network entity 105-b and the UE 115-b and manages aspects of the wireless communications with the UE 115-b. In some cases, due to power imbalance between the at least two antennas, channel estimation based on the one or more SRS may be inaccurate.

The UE 115-b may compensate for these inaccuracies by adjusting one or more power controls associated with the one or more antenna ports of the at least two antennas of the UE 115-b for the transmission of the one or more SRSs by the UE 115-b. For example, the network entity 105-b may determine one or more power control parameters (e.g., different power control parameters) for the one or more antenna ports of the at least two antennas of the UE 115-b for SRS transmission, and indicate the power control parameters to the UE 115-b to adjust the SRS transmission. Additionally, the network entity 105-b may determine the power control parameters based on the reported power imbalance between the at least two antennas.

At 625, the network entity 105-b may perform channel estimations based on the received one or more SRSs. At 630, the network entity 105-b may select a precoding matrix and determine a transmit precoding matrix indicator (TPMI) associated with the selected precoding matrix within a codebook (e.g., an uplink codebook) based on the received SRS. In some cases, the codebook may be of constant-value elements. At 635, the network entity 105-b may optionally transmit, and the UE 115-b may optionally receive, wireless communication over a PDCCH. In some cases, the PDCCH may include an uplink grant, which may indicate the TPMI and a rank indicator (RI) for the UE 115-b. At 640, the UE 115-b may optionally transmit, and the network entity 105-b may optionally receive, wireless communication over a PUSCH. For example, the UE 115-b optionally transmit, and the network entity 105-b may optionally receive, wireless communication based on the uplink grant.

FIG. 7 shows a block diagram 700 of a device 705 that supports managing power imbalances and power controls for antennas in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to managing power imbalances and power controls for antennas). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to managing power imbalances and power controls for antennas). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of managing power imbalances and power controls for antennas as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at the device 705 in accordance with examples as disclosed herein. For example, the communications manager 720 may be configured as or otherwise support a means for obtaining a power offset value between at least two antennas of a set of antennas associated with the device, where the power offset value indicates a power imbalance that corresponds to a difference in an antenna gain between the at least two antennas. The communications manager 720 may be configured as or otherwise support a means for outputting a report that includes an indication of the power offset value between the at least two antennas. The communications manager 720 may be configured as or otherwise support a means for performing the wireless communication based on the outputted report.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for reduced power consumption by managing power imbalances and power controls for antennas in accordance with one or more aspects of the present disclosure.

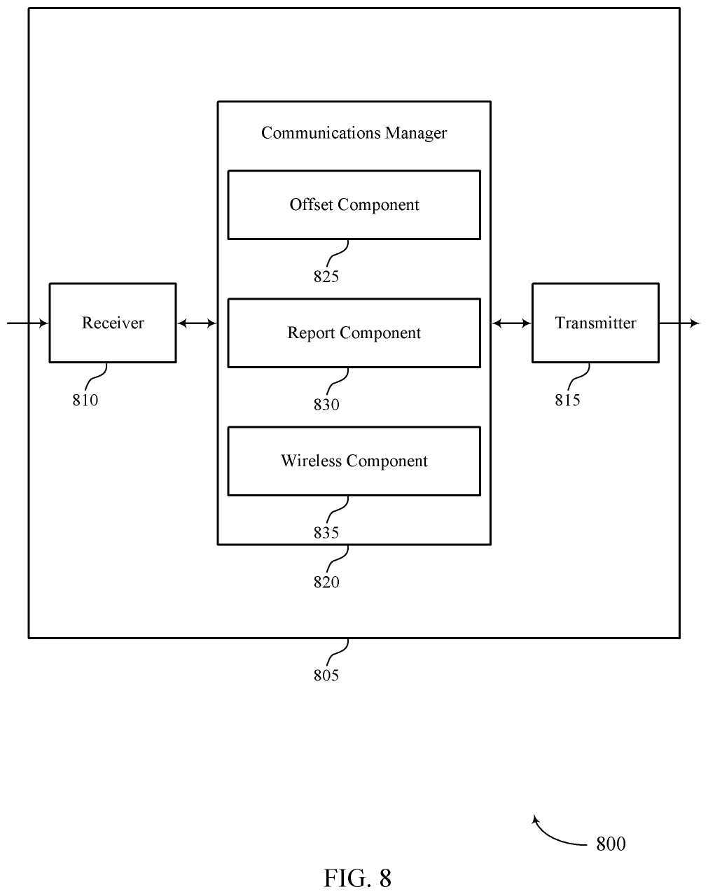

FIG. 8 shows a block diagram 800 of a device 805 that supports managing power imbalances and power controls for antennas in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to managing power imbalances and power controls for antennas). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to managing power imbalances and power controls for antennas). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of managing power imbalances and power controls for antennas as described herein. For example, the communications manager 820 may include an offset component 825, a report component 830, a wireless component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at the device 805 in accordance with examples as disclosed herein. The offset component 825 may be configured as or otherwise support a means for obtaining a power offset value between at least two antennas of a set of antennas associated with the device, where the power offset value indicates a power imbalance that corresponds to a difference in an antenna gain between the at least two antennas. The report component 830 may be configured as or otherwise support a means for outputting a report that includes an indication of the power offset value between the at least two antennas. The wireless component 835 may be configured as or otherwise support a means for performing the wireless communication based on the outputted report.

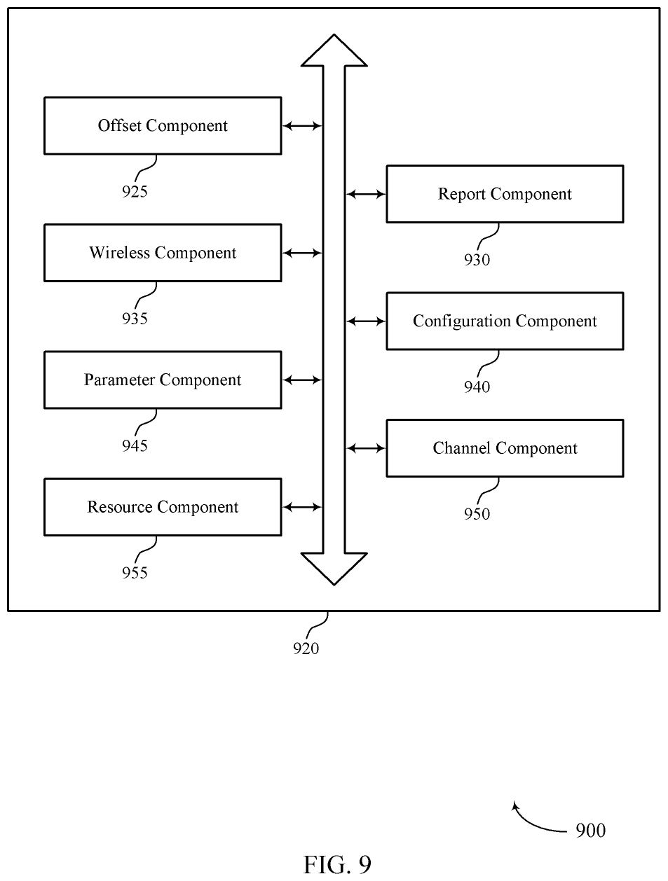

FIG. 9 shows a block diagram 900 of a communications manager 920 that supports managing power imbalances and power controls for antennas in accordance with one or more aspects of the present disclosure. The communications manager 920 may be an example of aspects of a communications manager 720, a communications manager 820, or both, as described herein. The communications manager 920, or various components thereof, may be an example of means for performing various aspects of managing power imbalances and power controls for antennas as described herein. For example, the communications manager 920 may include an offset component 925, a report component 930, a wireless component 935, a configuration component 940, a parameter component 945, a channel component 950, a resource component 955, or any combination thereof. Each of these components may communicate, directly or indirectly, with one another (e.g., via one or more buses).

The communications manager 920 may support wireless communication at a device in accordance with examples as disclosed herein. The offset component 925 may be configured as or otherwise support a means for obtaining a power offset value between at least two antennas of a set of antennas associated with the device, where the power offset value indicates a power imbalance that corresponds to a difference in an antenna gain between the at least two antennas. The report component 930 may be configured as or otherwise support a means for outputting a report that includes an indication of the power offset value between the at least two antennas. The wireless component 935 may be configured as or otherwise support a means for performing the wireless communication based on the outputted report.

In some examples, the configuration component 940 may be configured as or otherwise support a means for obtaining control signaling that indicates a configuration to report the power offset value between the at least two antennas. In some examples, the report component 930 may be configured as or otherwise support a means for outputting the report that includes the indication of the power offset value between the at least two antennas based on the configuration. In some examples, the control signaling includes an RRC message, a DCI, a MAC-CE, or a any combination thereof.

In some examples, the offset component 925 may be configured as or otherwise support a means for identifying a power offset threshold value based on the configuration. In some examples, the offset component 925 may be configured as or otherwise support a means for determining that the power offset value between the at least two antennas, or at least one respective power offset value associated with a respective antenna of the at least two antennas, or both, satisfies the determined power offset threshold value. In some examples, the report component 930 may be configured as or otherwise support a means for outputting the report that includes the indication of the power offset value between the at least two antennas based on that the power offset value between the at least two antennas, or at least one respective power offset value associated with a respective antenna of the at least two antennas, or both, satisfies the determined power offset threshold value.

In some examples, the offset component 925 may be configured as or otherwise support a means for setting the power offset value for the at least two antennas based on a respective antenna polarization of each antenna of the at least two antennas. In some examples, the offset component 925 may be configured as or otherwise support a means for setting the power offset value for the at least two antennas based on each antenna of the at least two antennas being configured to a respective antenna panel associated with the device. In some examples, the offset component 925 may be configured as or otherwise support a means for setting a respective power offset value separately for each antenna of the at least two antennas. In some examples, the parameter component 945 may be configured as or otherwise support a means for obtaining control signaling that indicates a respective power control parameter for one or more antenna ports associated with each of the at least two antennas based on the outputted report that includes the indication of the power offset value between the at least two antennas.

In some examples, the resource component 955 may be configured as or otherwise support a means for determining an SRS resource for the one or more antenna ports associated with each of the at least two antennas. In some examples, the respective power control parameter for the one or more antenna ports associated with each of the at least two antennas may be based on the SRS resource for the one or more antenna ports associated with each of the at least two antennas. In some examples, the SRS resource for the one or more antenna ports associated with each of the at least two antennas corresponds to an SRS resource associated with both the at least two antennas.

In some examples, the parameter component 945 may be configured as or otherwise support a means for identifying the respective power control parameter for the one or more antenna ports associated with each of the at least two antennas based on a respective antenna port index for the one or more antenna ports associated with each of the at least two antennas. In some examples, the SRS resource for the one or more antenna ports associated with each of the at least two antennas corresponds to different SRS resources. In some examples, the at least two antennas of the set of antennas corresponds to at least two antenna ports for PUSCH transmission, and each antenna port of the at least two antenna ports corresponds to a respective power control parameter.

In some examples, to support performing the wireless communication, the channel component 950 may be configured as or otherwise support a means for determining channel estimation on a channel based on the power offset value between the at least two antennas, the channel including an uplink channel. In some examples, the set of antennas, the at least two antennas of the set of antennas are associated with a transmit chain, a receiver chain, or both, associated with the apparatus. In some examples, the set of antennas include a non-uniform geometric shape. In some examples, the device includes a UE or a CPE.

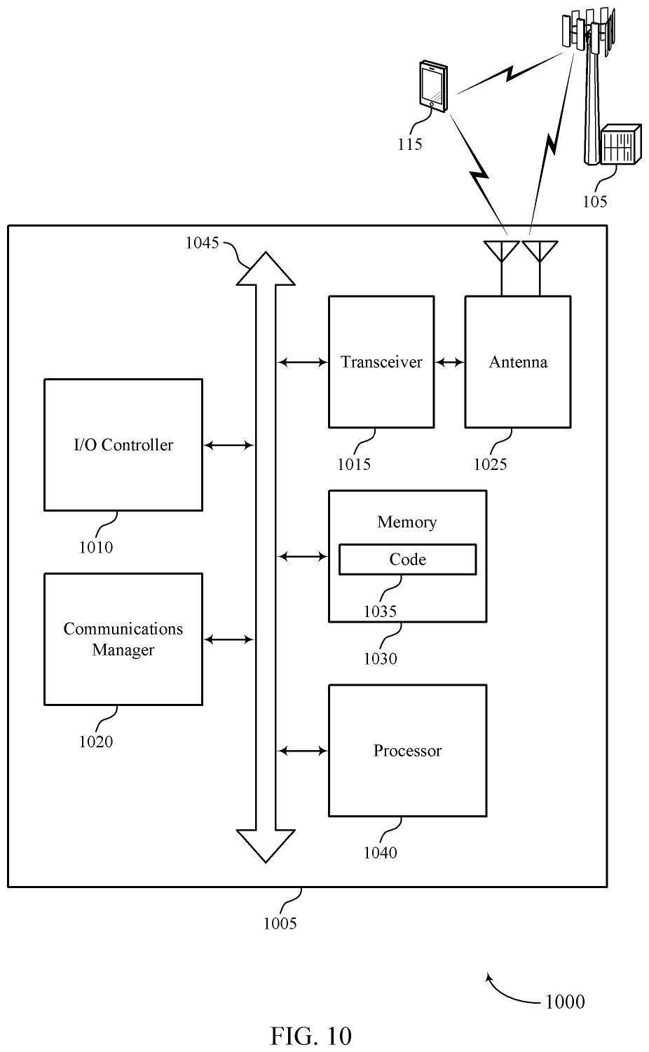

FIG. 10 shows a diagram of a system 1000 including a device 1005 that supports managing power imbalances and power controls for antennas in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting managing power imbalances and power controls for antennas). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at the device 1005 in accordance with examples as disclosed herein. For example, the communications manager 1020 may be configured as or otherwise support a means for obtaining a power offset value between at least two antennas of a set of antennas associated with the device, where the power offset value indicates a power imbalance that corresponds to a difference in an antenna gain between the at least two antennas. The communications manager 1020 may be configured as or otherwise support a means for outputting a report that includes an indication of the power offset value between the at least two antennas. The communications manager 1020 may be configured as or otherwise support a means for performing the wireless communication based on the outputted report.

By including or configuring the communications manager 1020 in accordance with examples as described herein, the device 1005 may support techniques for reduced power consumption by managing power imbalances and power controls for antennas in accordance with one or more aspects of the present disclosure.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of managing power imbalances and power controls for antennas as described herein, or the processor 1040 and the memory 1030 may be otherwise configured to perform or support such operations.

FIG. 11 shows a block diagram 1100 of a device 1105 that supports managing power imbalances and power controls for antennas in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of managing power imbalances and power controls for antennas as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity (e.g., the device 1105) in accordance with examples as disclosed herein. For example, the communications manager 1120 may be configured as or otherwise support a means for obtaining a report that includes an indication of a power offset value between at least two antennas of a set of antennas associated with a device, where the power offset value indicates a power imbalance that corresponds to a difference in an antenna gain between the at least two antennas. The communications manager 1120 may be configured as or otherwise support a means for performing the wireless communication with the device based on the report.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for more efficient utilization of communication resources by managing power imbalances and power controls for antennas in accordance with one or more aspects of the present disclosure.

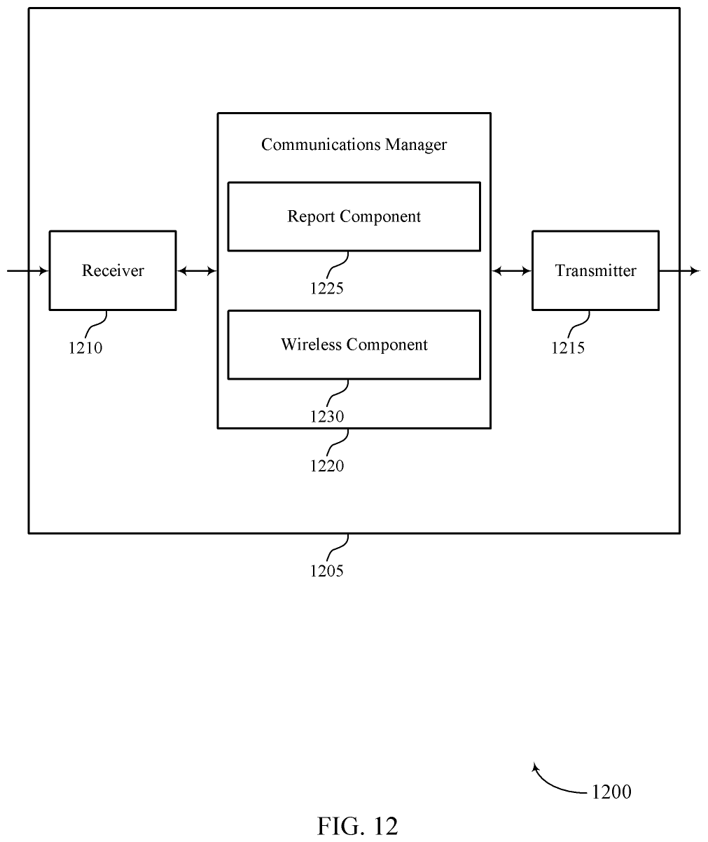

FIG. 12 shows a block diagram 1200 of a device 1205 that supports managing power imbalances and power controls for antennas in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of managing power imbalances and power controls for antennas as described herein. For example, the communications manager 1220 may include a report component 1225 a wireless component 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network entity (e.g., the device 1205) in accordance with examples as disclosed herein. The report component 1225 may be configured as or otherwise support a means for obtaining a report that includes an indication of a power offset value between at least two antennas of a set of antennas associated with a device, where the power offset value indicates a power imbalance that corresponds to a difference in an antenna gain between the at least two antennas. The wireless component 1230 may be configured as or otherwise support a means for performing the wireless communication with the device based on the report.

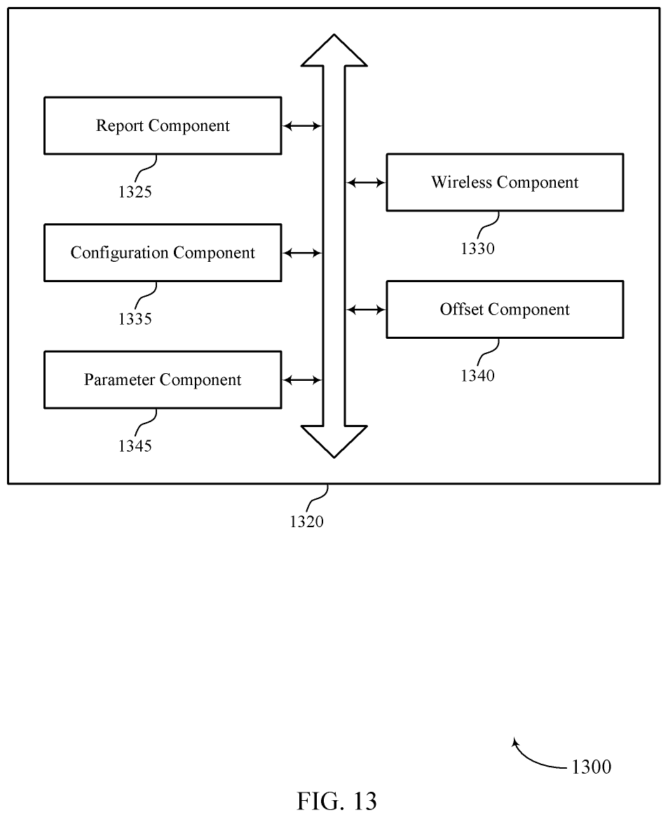

FIG. 13 shows a block diagram 1300 of a communications manager 1320 that supports managing power imbalances and power controls for antennas in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of managing power imbalances and power controls for antennas as described herein. For example, the communications manager 1320 may include a report component 1325, a wireless component 1330, a configuration component 1335, an offset component 1340, a parameter component 1345, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication at a network entity in accordance with examples as disclosed herein. The report component 1325 may be configured as or otherwise support a means for obtaining a report that includes an indication of a power offset value between at least two antennas of a set of antennas associated with a device, where the power offset value indicates a power imbalance that corresponds to a difference in an antenna gain between the at least two antennas. The wireless component 1330 may be configured as or otherwise support a means for performing the wireless communication with the device based on the report.

In some examples, the configuration component 1335 may be configured as or otherwise support a means for outputting control signaling that indicates a configuration to report the power offset value between the at least two antennas. In some examples, the report component 1325 may be configured as or otherwise support a means for obtaining the report that includes the indication of the power offset value between the at least two antennas based on the configuration. In some examples, the control signaling includes an RRC message, a DCI, a MAC-CE, or a any combination thereof. In some examples, the configuration indicates a power offset threshold value. In some examples, the report that includes the indication of the power offset value between the at least two antennas is based on that the power offset value between the at least two antennas, or at least one respective power offset value associated with a respective antenna of the at least two antennas, or both, satisfies the power offset threshold value.

In some examples, the offset component 1340 may be configured as or otherwise support a means for assigning a power offset value for the at least two antennas based on a respective antenna polarization of each antenna of the at least two antennas. In some examples, the offset component 1340 may be configured as or otherwise support a means for assigning the power offset value for the at least two antennas based on each antenna of the at least two antennas being configured to a respective antenna panel associated with the device. In some examples, the offset component 1340 may be configured as or otherwise support a means for assigning a respective power offset value separately for each antenna of the at least two antennas.

In some examples, the parameter component 1345 may be configured as or otherwise support a means for outputting control signaling that indicates a respective power control parameter for one or more antenna ports associated with each of the at least two antennas based on the report that includes the indication of the power offset value between the at least two antennas. In some examples, the respective power control parameter for the one or more antenna ports associated with each of the at least two antennas are based on an SRS resource for the one or more antenna ports associated with each of the at least two antennas. In some examples, the SRS resource for the one or more antenna ports associated with each of the at least two antennas corresponds to an SRS resource associated with both the at least two antennas. In some examples, the SRS resource for the one or more antenna ports associated with each of the at least two antennas corresponds to different SRS resources.

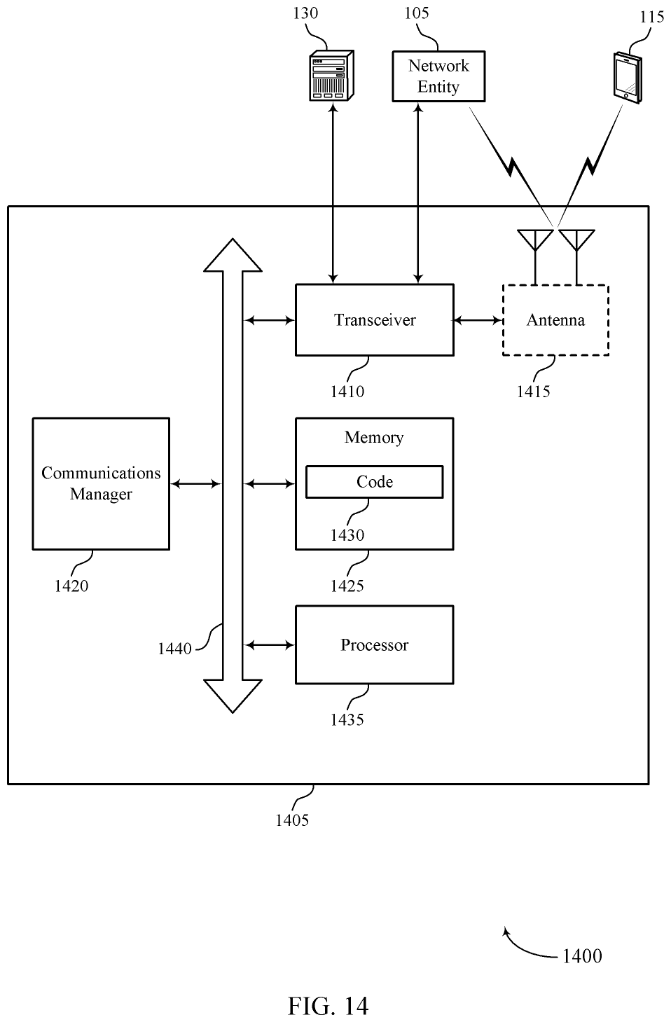

FIG. 14 shows a diagram of a system 1400 including a device 1405 that supports managing power imbalances and power controls for antennas in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. The transceiver 1410, or the transceiver 1410 and one or more antennas 1415 or wired interfaces, where applicable, may be an example of a transmitter 1115, a transmitter 1215, a receiver 1110, a receiver 1210, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting managing power imbalances and power controls for antennas). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication at a network entity (e.g., the device 1405) in accordance with examples as disclosed herein. For example, the communications manager 1420 may be configured as or otherwise support a means for obtaining a report that includes an indication of a power offset value between at least two antennas of a set of antennas associated with a device, where the power offset value indicates a power imbalance that corresponds to a difference in an antenna gain between the at least two antennas. The communications manager 1420 may be configured as or otherwise support a means for performing the wireless communication with the device based on the report.

By including or configuring the communications manager 1420 in accordance with examples as described herein, the device 1405 may support techniques for higher communication reliability, reduced latency, and better coordination between devices by managing power imbalances and power controls for antennas in accordance with one or more aspects of the present disclosure.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the processor 1435, the memory 1425, the code 1430, the transceiver 1410, or any combination thereof. For example, the code 1430 may include instructions executable by the processor 1435 to cause the device 1405 to perform various aspects of managing power imbalances and power controls for antennas as described herein, or the processor 1435 and the memory 1425 may be otherwise configured to perform or support such operations.

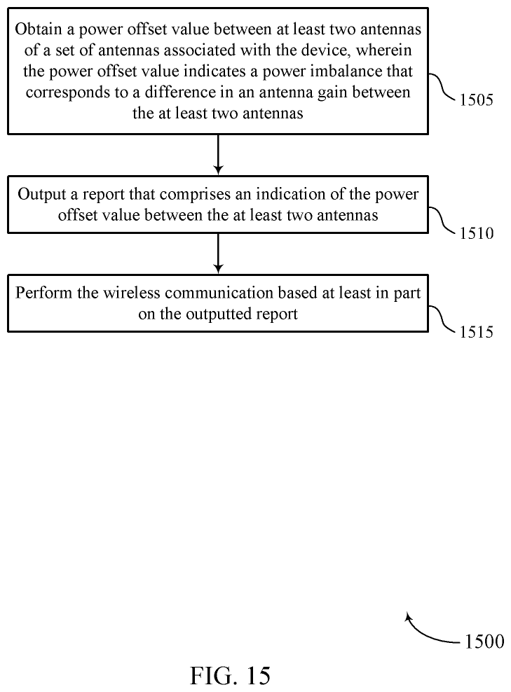

FIG. 15 shows a flowchart illustrating a method 1500 that supports managing power imbalances and power controls for antennas in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include obtaining a power offset value between at least two antennas of a set of antennas associated with the device, where the power offset value indicates a power imbalance that corresponds to a difference in an antenna gain between the at least two antennas. The operations of 1505 may be performed in accordance with examples as disclosed herein. In some examples, aspects of the operations of 1505 may be performed by an offset component 925 as described with reference to FIG. 9.

At 1510, the method may include outputting a report that includes an indication of the power offset value between the at least two antennas. The operations of 1510 may be performed in accordance with examples as disclosed herein. In some examples, aspects of the operations of 1510 may be performed by a report component 930 as described with reference to FIG. 9.

At 1515, the method may include performing the wireless communication based on the outputted report. The operations of 1515 may be performed in accordance with examples as disclosed herein. In some examples, aspects of the operations of 1515 may be performed by a wireless component 935 as described with reference to FIG. 9.

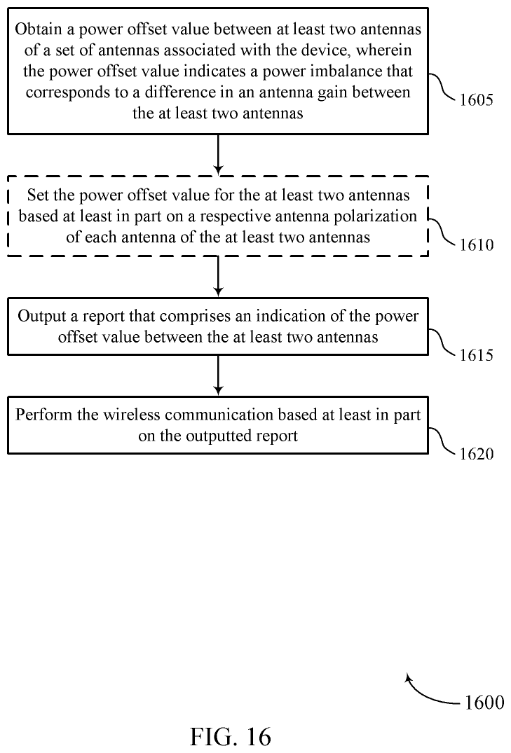

FIG. 16 shows a flowchart illustrating a method 1600 that supports managing power imbalances and power controls for antennas in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include obtaining a power offset value between at least two antennas of a set of antennas associated with the device, where the power offset value indicates a power imbalance that corresponds to a difference in an antenna gain between the at least two antennas. The operations of 1605 may be performed in accordance with examples as disclosed herein. In some examples, aspects of the operations of 1605 may be performed by an offset component 925 as described with reference to FIG. 9.

At 1610, the method may include setting the power offset value for the at least two antennas based on a respective antenna polarization of each antenna of the at least two antennas. The operations of 1610 may be performed in accordance with examples as disclosed herein. In some examples, aspects of the operations of 1610 may be performed by an offset component 925 as described with reference to FIG. 9.

At 1615, the method may include outputting a report that includes an indication of the power offset value between the at least two antennas. The operations of 1615 may be performed in accordance with examples as disclosed herein. In some examples, aspects of the operations of 1615 may be performed by a report component 930 as described with reference to FIG. 9.

At 1620, the method may include performing the wireless communication based on the outputted report. The operations of 1620 may be performed in accordance with examples as disclosed herein. In some examples, aspects of the operations of 1620 may be performed by a wireless component 935 as described with reference to FIG. 9.

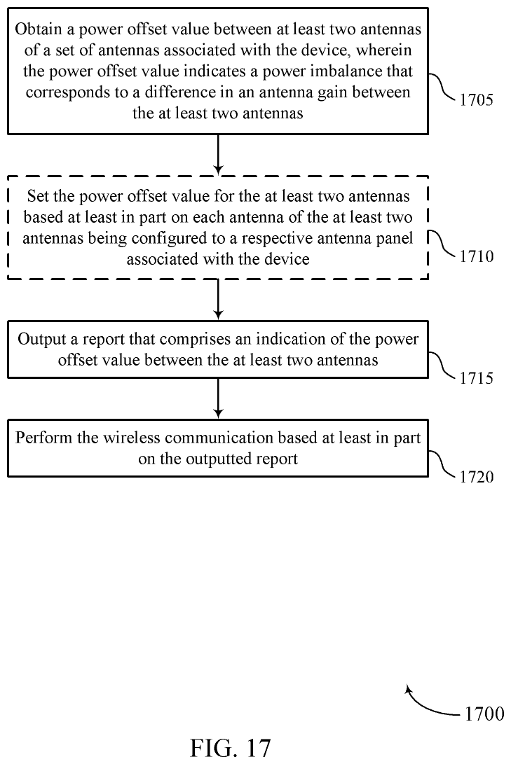

FIG. 17 shows a flowchart illustrating a method 1700 that supports managing power imbalances and power controls for antennas in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include obtaining a power offset value between at least two antennas of a set of antennas associated with the device, where the power offset value indicates a power imbalance that corresponds to a difference in an antenna gain between the at least two antennas. The operations of 1705 may be performed in accordance with examples as disclosed herein. In some examples, aspects of the operations of 1705 may be performed by an offset component 925 as described with reference to FIG. 9.

At 1710, the method may include setting the power offset value for the at least two antennas based on each antenna of the at least two antennas being configured to a respective antenna panel associated with the device. The operations of 1710 may be performed in accordance with examples as disclosed herein. In some examples, aspects of the operations of 1710 may be performed by an offset component 925 as described with reference to FIG. 9.

At 1715, the method may include outputting a report that includes an indication of the power offset value between the at least two antennas. The operations of 1715 may be performed in accordance with examples as disclosed herein. In some examples, aspects of the operations of 1715 may be performed by a report component 930 as described with reference to FIG. 9.

At 1720, the method may include performing the wireless communication based on the outputted report. The operations of 1720 may be performed in accordance with examples as disclosed herein. In some examples, aspects of the operations of 1720 may be performed by a wireless component 935 as described with reference to FIG. 9.

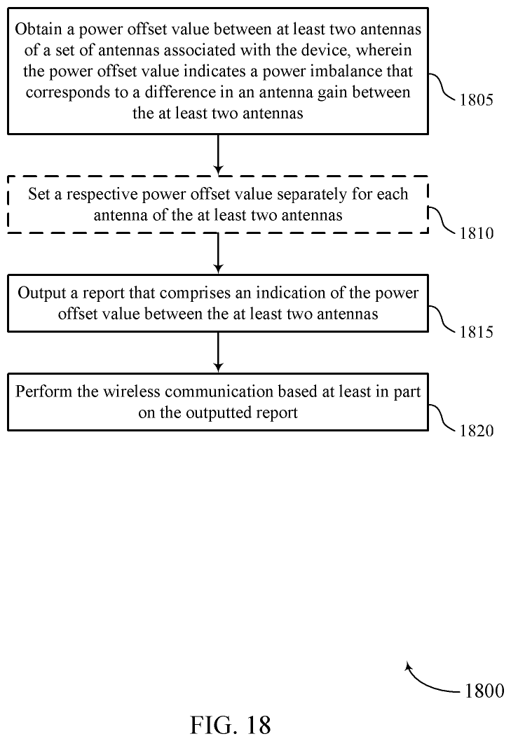

FIG. 18 shows a flowchart illustrating a method 1800 that supports managing power imbalances and power controls for antennas in accordance with one or more aspects of the present disclosure. The operations of the method 1800 may be implemented by a UE or its components as described herein. For example, the operations of the method 1800 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1805, the method may include obtaining a power offset value between at least two antennas of a set of antennas associated with the device, where the power offset value indicates a power imbalance that corresponds to a difference in an antenna gain between the at least two antennas. The operations of 1805 may be performed in accordance with examples as disclosed herein. In some examples, aspects of the operations of 1805 may be performed by an offset component 925 as described with reference to FIG. 9.

At 1810, the method may include setting a respective power offset value separately for each antenna of the at least two antennas. The operations of 1810 may be performed in accordance with examples as disclosed herein. In some examples, aspects of the operations of 1810 may be performed by an offset component 925 as described with reference to FIG. 9.

At 1815, the method may include outputting a report that includes an indication of the power offset value between the at least two antennas. The operations of 1815 may be performed in accordance with examples as disclosed herein. In some examples, aspects of the operations of 1815 may be performed by a report component 930 as described with reference to FIG. 9.

At 1820, the method may include performing the wireless communication based on the outputted report. The operations of 1820 may be performed in accordance with examples as disclosed herein. In some examples, aspects of the operations of 1820 may be performed by a wireless component 935 as described with reference to FIG. 9.

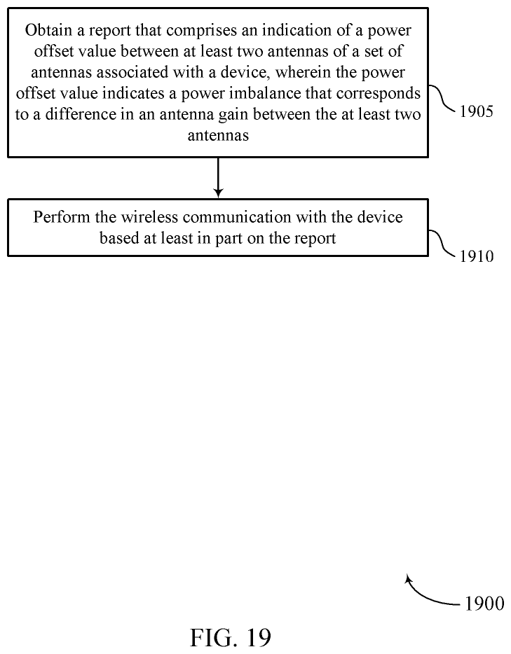

FIG. 19 shows a flowchart illustrating a method 1900 that supports managing power imbalances and power controls for antennas in accordance with one or more aspects of the present disclosure. The operations of the method 1900 may be implemented by a network entity or its components as described herein. For example, the operations of the method 1900 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1905, the method may include obtaining a report that includes an indication of a power offset value between at least two antennas of a set of antennas associated with a device, where the power offset value indicates a power imbalance that corresponds to a difference in an antenna gain between the at least two antennas. The operations of 1905 may be performed in accordance with examples as disclosed herein. In some examples, aspects of the operations of 1905 may be performed by a report component 1325 as described with reference to FIG. 13.

At 1910, the method may include performing the wireless communication with the device based on the report. The operations of 1910 may be performed in accordance with examples as disclosed herein. In some examples, aspects of the operations of 1910 may be performed by a wireless component 1330 as described with reference to FIG. 13.

It should be noted that the methods described herein describe possible implementations, and that the operations and the steps may be rearranged or otherwise modified and that other implementations are possible. Further, aspects from two or more of the methods may be combined.

The following provides an overview of aspects of the present disclosure:

Aspect 1: A method for wireless communication at a device, comprising: obtaining a power offset value between at least two antennas of a set of antennas associated with the device, wherein the power offset value indicates a power imbalance corresponding to a difference in an antenna gain between the at least two antennas; outputting a report comprising an indication of the power offset value between the at least two antennas; and performing the wireless communication based at least in part on the outputted report.

Aspect 2: The method of aspect 1, further comprising: obtaining control signaling that indicates a configuration to report the power offset value between the at least two antennas, wherein outputting the report comprising the indication of the power offset value between the at least two antennas is based at least in part on the configuration.

Aspect 3: The method of aspect 2, wherein the control signaling comprises an RRC message, a DCI, a MAC-CE, or any combination thereof.

Aspect 4: The method of any of aspects 2 through 3, further comprising: identifying a power offset threshold value based at least in part on the configuration; and determining that the power offset value between the at least two antennas, or at least one respective power offset value associated with a respective antenna of the at least two antennas, or both, satisfies the determined power offset threshold value, wherein outputting the report comprising the indication of the power offset value between the at least two antennas is further based at least in part on that the power offset value between the at least two antennas, or at least one respective power offset value associated with a respective antenna of the at least two antennas, or both, satisfies the determined power offset threshold value.

Aspect 5: The method of any of aspects 1 through 4, further comprising: setting the power offset value for the at least two antennas based at least in part on a respective antenna polarization of each antenna of the at least two antennas.

Aspect 6: The method of any of aspects 1 through 5, further comprising: setting the power offset value for the at least two antennas based at least in part on each antenna of the at least two antennas being configured to a respective antenna panel associated with the device.

Aspect 7: The method of any of aspects 1 through 6, further comprising: setting a respective power offset value separately for each antenna of the at least two antennas.

Aspect 8: The method of any of aspects 1 through 7, further comprising: obtaining control signaling that indicates a respective power control parameter for one or more antenna ports associated with each of the at least two antennas based at least in part on the outputted report comprising the indication of the power offset value between the at least two antennas.

Aspect 9: The method of aspect 8, further comprising: determining a SRS resource for the one or more antenna ports associated with each of the at least two antennas, wherein the respective power control parameter for the one or more antenna ports associated with each of the at least two antennas is based at least in part on the SRS resource for the one or more antenna ports associated with each of the at least two antennas.

Aspect 10: The method of aspect 9, wherein the SRS resource for the one or more antenna ports associated with each of the at least two antennas corresponds to a SRS resource associated with both the at least two antennas.

Aspect 11: The method of aspect 10, further comprising: identifying the respective power control parameter for the one or more antenna ports associated with each of the at least two antennas based at least in part on a respective antenna port index for the one or more antenna ports associated with each of the at least two antennas.

Aspect 12: The method of any of aspects 9 through 11, wherein the SRS resource for the one or more antenna ports associated with each of the at least two antennas corresponds to different SRS resources.

Aspect 13: The method of any of aspects 1 through 12, wherein the at least two antennas of the set of antennas corresponds to at least two antenna ports for physical uplink shared channel transmission, and each antenna port of the at least two antenna ports corresponds to a respective power control parameter.

Aspect 14: The method of any of aspects 1 through 13, wherein performing the wireless communication comprises: determining channel estimation on a channel based at least in part on the power offset value between the at least two antennas, the channel comprising an uplink channel.

Aspect 15: The method of any of aspects 1 through 14, further comprising the set of antennas, wherein the at least two antennas of the set of antennas are associated with a transmit chain, a receiver chain, or both, associated with the device.

Aspect 16: The method of any of aspects 1 through 15, wherein the set of antennas comprises a non-uniform geometric shape.

Aspect 17: The method of any of aspects 1 through 16, wherein the device comprises a UE or a CPE.

Aspect 18: A method for wireless communication at a network entity, comprising: obtaining a report comprising an indication of a power offset value between at least two antennas of a set of antennas associated with a device, wherein the power offset value indicates a power imbalance corresponding to a difference in an antenna gain between the at least two antennas; and performing the wireless communication with the device based at least in part on the report.

Aspect 19: The method of aspect 18, further comprising: outputting control signaling that indicates a configuration to report the power offset value between the at least two antennas, wherein obtaining the report comprising the indication of the power offset value between the at least two antennas is based at least in part on the configuration.

Aspect 20: The method of aspect 19, wherein the control signaling comprises an RRC message, a DCI, MAC-CE, or any combination thereof.

Aspect 21: The method of any of aspects 19 through 20, wherein the configuration indicates a power offset threshold value, and the report comprising the indication of the power offset value between the at least two antennas is based at least in part on that the power offset value between the at least two antennas, or at least one respective power offset value associated with a respective antenna of the at least two antennas, or both, satisfies the power offset threshold value.

Aspect 22: The method of any of aspects 18 through 21, further comprising: assigning a power offset value for the at least two antennas based at least in part on a respective antenna polarization of each antenna of the at least two antennas.

Aspect 23: The method of any of aspects 18 through 22, further comprising: assigning the power offset value for the at least two antennas based at least in part on each antenna of the at least two antennas being configured to a respective antenna panel associated with the device.

Aspect 24: The method of any of aspects 18 through 23, further comprising: assigning a respective power offset value separately for each antenna of the at least two antennas.

Aspect 25: The method of any of aspects 18 through 24, further comprising: outputting control signaling that indicates a respective power control parameter for one or more antenna ports associated with each of the at least two antennas based at least in part on the report comprising the indication of the power offset value between the at least two antennas.

Aspect 26: The method of aspect 25, wherein the respective power control parameter for the one or more antenna ports associated with each of the at least two antennas is based at least in part on a SRS resource for the one or more antenna ports associated with each of the at least two antennas.

Aspect 27: The method of aspect 26, wherein the SRS resource for the one or more antenna ports associated with each of the at least two antennas corresponds to an SRS resource associated with both the at least two antennas.

Aspect 28: The method of any of aspects 26 through 27, wherein the SRS resource for the one or more antenna ports associated with each of the at least two antennas corresponds to different SRS resources.

Aspect 29: An apparatus for wireless communication at a device, comprising a processor; memory coupled with the processor, the processor configured to perform a method of any of aspects 1 through 17.

Aspect 30: An apparatus for wireless communication at a device, comprising at least one means for performing a method of any of aspects 1 through 17.

Aspect 31: A non-transitory computer-readable medium storing code for wireless communication at a device, the code comprising instructions executable by a processor to perform a method of any of aspects 1 through 17.

Aspect 32: An apparatus for wireless communication at a network entity, comprising a processor; memory coupled with the processor, the processor configured to perform a method of any of aspects 18 through 28.

Aspect 33: An apparatus for wireless communication at a network entity, comprising at least one means for performing a method of any of aspects 18 through 28.

Aspect 34: A non-transitory computer-readable medium storing code for wireless communication at a network entity, the code comprising instructions executable by a processor to perform a method of any of aspects 18 through 28.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

As described herein, a node, which may be referred to as a node, a network node, a network entity, or a wireless node, may be a base station (e.g., any base station described herein), a UE (e.g., any UE described herein), a network controller, an apparatus, a device, a computing system, one or more components, and/or another suitable processing entity configured to perform any of the techniques described herein. For example, a network node may be a UE. As another example, a network node may be a base station. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a first one or more components, a first processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, including in the claims, the term “set” may include one or more members.

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication, comprising:
a processor; and
memory coupled with the processor, the processor configured to:
obtain a power offset value between at least two antennas of a set of antennas associated with the apparatus, wherein the power offset value indicates a power imbalance that corresponds to a difference in an antenna gain between the at least two antennas;
output a report that comprises an indication of the power offset value between the at least two antennas; and
perform the wireless communication based at least in part on the outputted report.

2. The apparatus of claim 1, wherein the processor is further configured to:
obtain control signaling that indicates a configuration to report the power offset value between the at least two antennas,
wherein to output the report that comprises the indication of the power offset value between the at least two antennas is based at least in part on the configuration.

3. The apparatus of claim 2, wherein the control signaling comprises a radio resource control (RRC) message, a downlink control information (DCI), a medium access control-control element (MAC-CE), or any combination thereof.

4. The apparatus of claim 2, wherein the processor is further configured to:
identify a power offset threshold value based at least in part on the configuration; and
determine that the power offset value between the at least two antennas, or at least one respective power offset value associated with a respective antenna of the at least two antennas, or both, satisfies the determined power offset threshold value,
wherein to output the report that comprises the indication of the power offset value between the at least two antennas is further based at least in part on that the power offset value between the at least two antennas, or at least one respective power offset value associated with a respective antenna of the at least two antennas, or both, satisfies the determined power offset threshold value.

5. The apparatus of claim 1, wherein the processor is further configured to:
set the power offset value for the at least two antennas based at least in part on a respective antenna polarization of each antenna of the at least two antennas.

6. The apparatus of claim 1, wherein the processor is further configured to:
set the power offset value for the at least two antennas based at least in part on each antenna of the at least two antennas being configured to a respective antenna panel associated with the apparatus.

7. The apparatus of claim 1, wherein the processor is further configured to:
set a respective power offset value separately for each antenna of the at least two antennas.

8. The apparatus of claim 1, wherein the processor is further configured to:
obtain control signaling that indicates a respective power control parameter for one or more antenna ports associated with each of the at least two antennas based at least in part on the outputted report that comprises the indication of the power offset value between the at least two antennas.

9. The apparatus of claim 8, wherein the processor is further configured to:
determine a sounding reference signal resource for the one or more antenna ports associated with each of the at least two antennas,
wherein the respective power control parameter for the one or more antenna ports associated with each of the at least two antennas is based at least in part on the sounding reference signal resource for the one or more antenna ports associated with each of the at least two antennas.

10. The apparatus of claim 9, wherein the sounding reference signal resource for the one or more antenna ports associated with each of the at least two antennas corresponds to a sounding reference signal resource associated with both the at least two antennas.

11. The apparatus of claim 10, wherein the processor is further configured to:
identify the respective power control parameter for the one or more antenna ports associated with each of the at least two antennas based at least in part on a respective antenna port index for the one or more antenna ports associated with each of the at least two antennas.

12. The apparatus of claim 9, wherein the sounding reference signal resource for the one or more antenna ports associated with each of the at least two antennas corresponds to different sounding reference signal resources.

13. The apparatus of claim 1, wherein the at least two antennas of the set of antennas corresponds to at least two antenna ports for physical uplink shared channel transmission, and each antenna port of the at least two antenna ports corresponds to a respective power control parameter.

14. The apparatus of claim 1, wherein, to perform the wireless communication, the processor is configured to:
determine channel estimation on a channel based at least in part on the power offset value between the at least two antennas.

15. The apparatus of claim 1, further comprising: the set of antennas, wherein the at least two antennas of the set of antennas are associated with a transmit chain, a receiver chain, or both, associated with the apparatus.

16. The apparatus of claim 1, wherein the set of antennas comprises a non-uniform geometric shape.

17. The apparatus of claim 1, wherein the apparatus comprises a user equipment (UE) or a customer premise equipment (CPE).

18. An apparatus for wireless communication, comprising:
a processor; and
memory coupled with the processor, the processor configured to:
obtain a report that comprises an indication of a power offset value between at least two antennas of a set of antennas associated with a device, wherein the power offset value indicates a power imbalance that corresponds to a difference in an antenna gain between the at least two antennas; and
perform the wireless communication with the device based at least in part on the report.

19. The apparatus of claim 18, wherein the processor is further configured to:
output control signaling that indicates a configuration to report the power offset value between the at least two antennas,
wherein to obtain the report that comprises the indication of the power offset value between the at least two antennas is based at least in part on the configuration.

20. The apparatus of claim 19, wherein the control signaling comprises a radio resource control (RRC) message, a downlink control information (DCI), a medium access control-control element (MAC-CE), or any combination thereof.

21. The apparatus of claim 19, wherein the configuration indicates a power offset threshold value, and the report that comprises the indication of the power offset value between the at least two antennas is based at least in part on that the power offset value between the at least two antennas, or at least one respective power offset value associated with a respective antenna of the at least two antennas, or both, satisfies the power offset threshold value.

22. The apparatus of claim 18, wherein the processor is further configured to:
assign a power offset value for the at least two antennas based at least in part on a respective antenna polarization of each antenna of the at least two antennas.

23. The apparatus of claim 18, wherein the processor is further configured to:
assign the power offset value for the at least two antennas based at least in part on each antenna of the at least two antennas configured to a respective antenna panel associated with the device.

24. The apparatus of claim 18, wherein the processor is further configured to:
assign a respective power offset value separately for each antenna of the at least two antennas.

25. The apparatus of claim 18, wherein the processor is further configured to:
output control signaling that indicates a respective power control parameter for one or more antenna ports associated with each of the at least two antennas based at least in part on the report that comprises the indication of the power offset value between the at least two antennas.

26. The apparatus of claim 25, wherein the respective power control parameter for the one or more antenna ports associated with each of the at least two antennas is based at least in part on a sounding reference signal resource for the one or more antenna ports associated with each of the at least two antennas.

27. The apparatus of claim 26, wherein the sounding reference signal resource for the one or more antenna ports associated with each of the at least two antennas corresponds to a sounding reference signal resource associated with both the at least two antennas.

28. The apparatus of claim 26, wherein the sounding reference signal resource for the one or more antenna ports associated with each of the at least two antennas corresponds to different sounding reference signal resources.

29. A method for wireless communication at a device, comprising:
obtaining a power offset value between at least two antennas of a set of antennas associated with the device, wherein the power offset value indicates a power imbalance that corresponds to a difference in an antenna gain between the at least two antennas;
outputting a report that comprises an indication of the power offset value between the at least two antennas; and
performing the wireless communication based at least in part on the outputted report.

30. A method for wireless communication at a network entity, comprising:
obtaining a report that comprises an indication of a power offset value between at least two antennas of a set of antennas associated with a device, wherein the power offset value indicates a power imbalance that corresponds to a difference in an antenna gain between the at least two antennas; and
performing the wireless communication with the device based at least in part on the report.
